(19) United States
(12) Patent Application Publication
(10) Pub. No.: US 2025/0158692 A1
(43) Pub. Date: May 15, 2025

(54) BEAM REFINEMENT USING NEIGHBORING UE REFERENCE SIGNALING

(71) Applicant: QUALCOMM Incorporated, San Diego, CA (US)

(72) Inventors: Peer BERGER, Hod Hasharon (IL); Shay LANDIS, Hod Hasharon (IL); Jacob PICK, Mevaseret Zion (IL)

(21) Appl. No.: 18/510,549

(22) Filed: Nov. 15, 2023

(51) Int. Cl. H04B 7/06

(52) U.S. Cl. CPC H04B 7/06966

(57) ABSTRACT

Methods, systems, and devices for wireless communication are described. A first user equipment may receive, from a network entity, information indicating a resource allocation associated with a physical downlink shared channel (PDSCH) for a second user equipment and an indication to measure a demodulation reference signal (DMRS) associated with the PDSCH for the second user equipment. The second user equipment may be in spatial angular proximity to the first user equipment. The first user equipment may measure the DMRS associated with the second user equipment, and may transmit, to the network entity, a beam management report including measurements associated with the DMRS for the second user equipment. Based on the measurements associated with the DMRS for the second user equipment, the network entity may adjust a directional beam associated with the first user equipment.

### FIELD OF TECHNOLOGY

The following relates to wireless communication, including beam refinement using neighboring user equipment reference signaling.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

Some wireless communications technologies, such as 5G, may use a range of frequency bands for communications, and the various frequency bands may provide varying levels of performance, speed, and coverage in order to support different applications of the wireless technology. Of the frequency bands used, high frequency bands, such as those in the frequency range 2 (FR2) and subThz range, may provide high levels of speed and ultra-low latency, however, they may also experience greater amounts of pathloss as compared to lower frequency bands. As a result, higher frequency bands may utilize narrow beams to overcome the greater amounts of path loss that occur at the high carrier frequencies. These narrow beams may help to mitigate path loss by concentrating signals in a specific direction towards a specific receiver, thereby resulting in increased antenna gain, enhanced signal strength, reduced interference, improved signal-to-noise ratio (SNR), and the like. These effects may, in turn, compensate for the path loss resulting from the higher frequency bands. Further, the short wavelengths that characterize high frequency bands may allow for the use of antennas that are physically smaller in size than those designed for lower frequency bands. This may allow for an increased quantity of antennas and antenna ports to be placed within a physical space of a device. As a result, a UE, for example, which may be limited by its size, may be capable of having an increased quantity of antennas for communications using higher frequency bands, resulting in narrower beams with higher directional gains because, with more antennas, the beams may be directed more precisely.

One of the challenges that may arise with the utilization of narrow beams is performing acquisition and tracking of the beams at both the UE and the network entity. This is because, when there are many beams and they are each fairly narrow, the UE and the network entity may need to know which beam needs to be operated. As the beam becomes narrower, the spatial search space increases. Thus, the UE and the network entity both expend time and power resources transmitting and detecting the different possible spatial beams. This beam management process may be divided into two phases. During a first phase of the beam management process, referred to as a P1 process, the UE may search for and acquire an initial beam from a network entity. For instance, initially the UE may use synchronization signal blocks (SSBs) broadcast by network entity of cells within the vicinity of the UE to facilitate identification of and synchronization to potential serving cells within the vicinity of the UE. The SSBs may additionally provide information about the beams transmitted by the network entity of the associated cell. The UE may utilize the information provided by the SSBs to select an appropriate beam (e.g., based on the signal quality of the beam) for initial communication with the corresponding cell. Once a suitable beam is selected, the UE may initiate the process of establishing an initial connection with the cell, such as through a random access procedure. The initially acquired beam may be further refined during a second phase of the beam management process, referred to as a P2 process. During the P2 process, the UE and network entity may coordinate the refinement and tracking of the beam over which the UE and the network entity are communicating, in order to ensure the most optimal beam is being used. To accomplish this, the UE may monitor the quality of the beam using special channel state information-reference signals (CSI-RSs) transmitted by the network entity for beam management. The UE may provide feedback to the network entity related to the beam's quality and the network entity may use this feedback to adjust the beam as necessary to ensure a reliable connection with the UE. The transmission of the CSI-RSs for measuring the beam quality, however, may occupy resources and spectrum that might, otherwise, be used to convey other network data. Techniques for efficiently performing beam management may help to improve overall cell capacity and utilization, thereby enhancing network efficiency and reliability.

### SUMMARY

The described techniques relate to improved methods, systems, devices, and apparatuses that support beam refinement using neighboring UE reference signaling (e.g., physical downlink shared channel (PDSCH) demodulation reference signals (DMRSs)) in wireless communications systems. In accordance with various aspects, the described techniques provide for the utilization, by a first UE, of PDSCH DMRSs transmitted to one or more neighboring UEs. The first UE may use the PDSCH DRMRSs of a neighboring UEs to refine a beam over which the first UE is communicating. For example, after establishing a connection with a network entity using an initial beam, there may be a need to determine whether refinement of the beam currently serving the first UE is necessary. Accordingly, the network entity may identify a second UE that is in proximity to the first UE and may transmit, to the first UE, control signaling providing an indication of a resource allocation associated with a PDSCH for the second UE. The control signaling may further indicate that the first UE is to use the DMRS within the resource allocation associated with the PDSCH for the second UE to measure a quality of a beam associated with the second UE. In response to the control signaling, the first UE may perform the measuring and may transmit a beam management report to the network entity reporting the measurements associated with the DMRS for the second UE. The network entity may compare the measurements received in the beam management report to previous measurements performed on the beams serving the first UE and/or the second UE or on other beams. Based on the comparison, the network entity, may determine whether it may be necessary to adjust the beam serving the first UE to ensure that the first UE is communicating over the most optimal beam. Such techniques may conserve resources by avoiding the utilization of CSI-RSs for performing beam management. This in turn may improve overall cell capacity and utilization, thereby enhancing network efficiency and reliability.

A method for wireless communications by a first user equipment is described. The method may include receiving control signaling including an indication of a resource allocation associated with a physical downlink shared channel for a second user equipment and an indication to measure a demodulation reference signal associated with the physical downlink shared channel for the second user equipment, measuring, based on receiving the control signaling, the demodulation reference signal associated with the physical downlink shared channel for the second user equipment, and transmitting, to a network device and based on measuring the demodulation reference signal associated with the physical downlink shared channel for the second user equipment, signaling including a beam management report.

A first user equipment for wireless communications is described. The first user equipment may include one or more memories storing processor executable code, and one or more processors coupled with the one or more memories. The one or more processors may individually or collectively operable to execute the code to cause the first user equipment to receive control signaling including an indication of a resource allocation associated with a physical downlink shared channel for a second user equipment and an indication to measure a demodulation reference signal associated with the physical downlink shared channel for the second user equipment, measure, based on receiving the control signaling, the demodulation reference signal associated with the physical downlink shared channel for the second user equipment, and transmit, to a network device and based on measuring the demodulation reference signal associated with the physical downlink shared channel for the second user equipment, signaling including a beam management report.

Another first user equipment for wireless communications is described. The first user equipment may include means for receiving control signaling including an indication of a resource allocation associated with a physical downlink shared channel for a second user equipment and an indication to measure a demodulation reference signal associated with the physical downlink shared channel for the second user equipment, means for measuring, based on receiving the control signaling, the demodulation reference signal associated with the physical downlink shared channel for the second user equipment, and means for transmitting, to a network device and based on measuring the demodulation reference signal associated with the physical downlink shared channel for the second user equipment, signaling including a beam management report.

A non-transitory computer-readable medium storing code for wireless communications is described. The code may include instructions executable by a processor to receive control signaling including an indication of a resource allocation associated with a physical downlink shared channel for a second user equipment and an indication to measure a demodulation reference signal associated with the physical downlink shared channel for the second user equipment, measure, based on receiving the control signaling, the demodulation reference signal associated with the physical downlink shared channel for the second user equipment, and transmit, to a network device and based on measuring the demodulation reference signal associated with the physical downlink shared channel for the second user equipment, signaling including a beam management report.

In some examples of the method, first user equipment, and non-transitory computer-readable medium described herein, the control signaling further includes an indication that the resource allocation may be associated with the second user equipment.

In some examples of the method, first user equipment, and non-transitory computer-readable medium described herein, the control signaling further includes an indication of one or more metrics to measure.

Some examples of the method, first user equipment, and non-transitory computer-readable medium described herein may further include operations, features, means, or instructions for measuring the demodulation reference signal includes measuring, using the demodulation reference signal, the one or more metrics.

In some examples of the method, first user equipment, and non-transitory computer-readable medium described herein, and the method, apparatuses, and non-transitory computer-readable medium may include further operations, features, means, or instructions for where measuring the demodulation reference signal includes measuring, using the demodulation reference signal, the one or more metrics within each allocated sub-band.

In some examples of the method, first user equipment, and non-transitory computer-readable medium described herein, the one or more metrics include a reference signal received power, a spectral efficiency, or a combination thereof.

Some examples of the method, first user equipment, and non-transitory computer-readable medium described herein may further include operations, features, means, or instructions for decoding the control signaling to determine: one or more resource blocks within the resource allocation including the demodulation reference signal, and a quantity of demodulation reference signal ports associated with the demodulation reference signal.

In some examples of the method, first user equipment, and non-transitory computer-readable medium described herein, the control signaling further includes an indication to transmit, to the network device, the signaling including the beam management report.

In some examples of the method, first user equipment, and non-transitory computer-readable medium described herein, the control signaling further includes an indication of a partial resource allocation to use for transmitting the signaling including the beam management report.

In some examples of the method, first user equipment, and non-transitory computer-readable medium described herein, the control signaling may be received in downlink control information or a medium access control-control element.

In some examples of the method, first user equipment, and non-transitory computer-readable medium described herein, the demodulation reference signal includes a unicast demodulation reference signal.

Some examples of the method, first user equipment, and non-transitory computer-readable medium described herein may further include operations, features, means, or instructions for establishing, prior to receiving the control signaling and based on a synchronization signal block, a connection with the network device via a first directional beam.

Some examples of the method, first user equipment, and non-transitory computer-readable medium described herein may further include operations, features, means, or instructions for receiving, from the network device and responsive to transmission of the signaling including the beam management report, a message notifying the first user equipment to switch from a first directional beam to a second directional beam.

In some examples of the method, first user equipment, and non-transitory computer-readable medium described herein, the second directional beam may be associated with the second user equipment.

In some examples of the method, first user equipment, and non-transitory computer-readable medium described herein, the second directional beam may be a directional beam associated with a third user equipment.

In some examples of the method, first user equipment, and non-transitory computer-readable medium described herein, the second directional beam may be a newly-configured directional beam.

Some examples of the method, first user equipment, and non-transitory computer-readable medium described herein may further include operations, features, means, or instructions for receiving, from the network device, a subsequent data transmission via the second directional beam.

In some examples of the method, first user equipment, and non-transitory computer-readable medium described herein, the second user equipment may be in spatial angular proximity to the first user equipment.

Some examples of the method, first user equipment, and non-transitory computer-readable medium described herein may further include operations, features, means, or instructions for transmitting, to the network device, second signaling recommending a spatial direction of a directional beam to be associated with the first user equipment, a different directional beam to be associated with the first user equipment, or a combination thereof.

In some examples of the method, first user equipment, and non-transitory computer-readable medium described herein, the second signaling may be transmitted based on movement detected at the first user equipment, a changed location of the first user equipment, or a changed direction of the first user equipment.

In some examples of the method, first user equipment, and non-transitory computer-readable medium described herein, the second signaling indicates a direction of movement of the first user equipment.

A method for wireless communication by a network device is described. The method may include transmitting, to a first user equipment, control signaling including an indication of a resource allocation associated with a physical downlink shared channel for a second user equipment and an indication to measure a demodulation reference signal associated with the physical downlink shared channel for the second user equipment, receiving, from the first user equipment, signaling including a beam management report including measurements associated with the demodulation reference signal associated with the physical downlink shared channel for the second user equipment, and adjusting, based on the beam management report, a directional beam associated with the first user equipment.

A network device for wireless communication is described. The network device may include one or more memories storing processor executable code, and one or more processors coupled with the one or more memories. The one or more processors may individually or collectively operable to execute the code to cause the network device to transmit, to a first user equipment, control signaling including an indication of a resource allocation associated with a physical downlink shared channel for a second user equipment and an indication to measure a demodulation reference signal associated with the physical downlink shared channel for the second user equipment, receive, from the first user equipment, signaling including a beam management report including measurements associated with the demodulation reference signal associated with the physical downlink shared channel for the second user equipment, and adjusting, base at least in part on the beam management report, a directional beam associated with the first user equipment.

Another network device for wireless communication is described. The network device may include means for transmitting, to a first user equipment, control signaling including an indication of a resource allocation associated with a physical downlink shared channel for a second user equipment and an indication to measure a demodulation reference signal associated with the physical downlink shared channel for the second user equipment, means for receiving, from the first user equipment, signaling including a beam management report including measurements associated with the demodulation reference signal associated with the physical downlink shared channel for the second user equipment, and means for adjusting, based on the beam management report, a directional beam associated with the first user equipment.

A non-transitory computer-readable medium storing code for wireless communication is described. The code may include instructions executable by a processor to transmit, to a first user equipment, control signaling including an indication of a resource allocation associated with a physical downlink shared channel for a second user equipment and an indication to measure a demodulation reference signal associated with the physical downlink shared channel for the second user equipment, receive, from the first user equipment, signaling including a beam management report including measurements associated with the demodulation reference signal associated with the physical downlink shared channel for the second user equipment, and adjusting, base at least in part on the beam management report, a directional beam associated with the first user equipment.

In some examples of the method, network devices, and non-transitory computer-readable medium described herein, in response to receiving the signaling including the beam management report: comparing, based on the beam management report, the measurements associated with the demodulation reference signal associated with the physical downlink shared channel for the second user equipment to previous measurements; and transmitting, to the first user equipment and based on the comparing, a notification to switch from a first directional beam to a different directional beam.

In some examples of the method, network devices, and non-transitory computer-readable medium described herein, where the previous measurements may be associated with the second directional beam and one or more additional directional beams.

In some examples of the method, network devices, and non-transitory computer-readable medium described herein, the previous measurements include synchronization signal block measurements, channel state information-reference signal measurements, unicast demodulation reference signal measurements, or a combination thereof.

In some examples of the method, network devices, and non-transitory computer-readable medium described herein, the previous measurements may be based on measurements performed by one or more other user equipments different from the first user equipment.

In some examples of the method, network devices, and non-transitory computer-readable medium described herein, the adjusting includes causing the first user equipment to switch from a first directional beam to a second directional beam.

In some examples of the method, network devices, and non-transitory computer-readable medium described herein, the second directional beam may be associated with the second user equipment.

In some examples of the method, network devices, and non-transitory computer-readable medium described herein, the second directional beam may be associated with a third user equipment.

In some examples of the method, network devices, and non-transitory computer-readable medium described herein, the second directional beam may be a newly-configured directional beam.

In some examples of the method, network devices, and non-transitory computer-readable medium described herein, the adjusting may include operations, features, means, or instructions for configuring a new directional beam, where the new directional beam may be not associated with the first user equipment or the second user equipment, aligning the new directional beam with a position of the first user equipment, and causing the first user equipment to switch from a first directional beam to the new directional beam.

Some examples of the method, network devices, and non-transitory computer-readable medium described herein may further include operations, features, means, or instructions for receiving, from the first user equipment, second signaling recommending a spatial direction of the directional beam to be associated with the first user equipment, a different directional beam to be associated with the first user equipment, or a combination thereof.

In some examples of the method, network devices, and non-transitory computer-readable medium described herein, the second signaling indicates a direction of movement of the first user equipment.

Some examples of the method, network devices, and non-transitory computer-readable medium described herein may further include operations, features, means, or instructions for transmitting, to the first user equipment and in response to the second signaling, second control signaling including an indication of a second resource allocation associated with a second physical downlink shared channel for another user equipment and an indication to measure a second demodulation reference signal associated with the physical downlink shared channel for the other user equipment.

In some examples of the method, network devices, and non-transitory computer-readable medium described herein, the control signaling further includes an indication that the resource allocation may be associated with the second user equipment.

In some examples of the method, network devices, and non-transitory computer-readable medium described herein, the control signaling further includes an indication of one or more metrics to measure.

In some examples of the method, network devices, and non-transitory computer-readable medium described herein, the control signaling further includes an indication to measure the one or more metrics within each allocated sub-band.

In some examples of the method, network devices, and non-transitory computer-readable medium described herein, the one or more metrics include a reference signal received power, a spectral efficiency, or a combination thereof.

In some examples of the method, network devices, and non-transitory computer-readable medium described herein, the control signaling further includes an indication to transmit, to the network device, the signaling including the beam management report.

In some examples of the method, network devices, and non-transitory computer-readable medium described herein, the control signaling further includes an indication of a partial resource allocation to use for transmitting the signaling including the beam management report.

In some examples of the method, network devices, and non-transitory computer-readable medium described herein, the control signaling may be transmitted in downlink control information or a medium access control-control element.

In some examples of the method, network devices, and non-transitory computer-readable medium described herein, the demodulation reference signal associated includes a unicast demodulation reference signal.

Some examples of the method, network devices, and non-transitory computer-readable medium described herein may further include operations, features, means, or instructions for establishing, prior to receiving the control signaling and based on a synchronization signal block, a connection with the first user equipment via a first directional beam.

In some examples of the method, network devices, and non-transitory computer-readable medium described herein, the second user equipment may be in spatial angular proximity to the first user equipment.

### BRIEF DESCRIPTION OF THE DRAWINGS

FIG. 1 shows an example of a wireless communications system that supports beam refinement using neighboring UE reference signaling in accordance with one or more aspects of the present disclosure.

FIGS. 2A, 2B, 3 and 4 and show an examples of wireless communications system environments that support beam refinement using neighboring UE reference signaling in accordance with one or more aspects of the present disclosure.

FIG. 5 shows an example of a process flow that supports beam refinement using neighboring UE reference signaling in accordance with one or more aspects of the present disclosure.

FIGS. 6 and 7 show block diagrams of devices that support beam refinement using neighboring UE reference signaling in accordance with one or more aspects of the present disclosure.

FIG. 8 shows a block diagram of a communications manager that supports beam refinement using neighboring UE reference signaling in accordance with one or more aspects of the present disclosure.

FIG. 9 shows a diagram of a system including a device that supports beam refinement using neighboring UE reference signaling in accordance with one or more aspects of the present disclosure.

FIGS. 10 and 11 show block diagrams of devices that support beam refinement using neighboring UE reference signaling in accordance with one or more aspects of the present disclosure.

FIG. 12 shows a block diagram of a communications manager that supports beam refinement using neighboring UE reference signaling in accordance with one or more aspects of the present disclosure.

FIG. 13 shows a diagram of a system including a device that supports beam refinement using neighboring UE reference signaling in accordance with one or more aspects of the present disclosure.

FIGS. 14 through 19 show flowcharts illustrating methods that support beam refinement using neighboring UE reference signaling in accordance with one or more aspects of the present disclosure.

### DETAILED DESCRIPTION

Various aspects of the present disclosure relate to beam refinement using reference signaling (e.g., PDSCH DMRSs) of neighboring UEs in wireless communications systems. In some wireless communication systems, a beam management process may be used to ensure that a receiving device, such as a UE, and a transmitting device, such as a network entity, are communicating using the most optimal beam. For instance, after a UE initially acquires a suitable beam for communicating with a network entity, there may at some point be a need to refine the beam over which the UE and the network entity are communicating. This may occur because the UE is moving in a different direction or has moved to a different location, because the signal quality has degraded, to mitigate interference from neighboring cells, or other reasons. During the beam refinement process, the UE and network entity may coordinate the refinement and tracking of the beam over which the UE and the network entity are communicating, in order to ensure the most optimal beam is being used. To accomplish this, the UE may monitor the quality of the beam using special CSI-RSs transmitted by the network entity for beam management. The transmission of such CSI-RSs for measuring the beam quality, however, may occupy resources and spectrum that might, otherwise, have been used to convey other important network data, thus, resulting in poor utilization of system resources overall and decreased capacity at a corresponding cell associated with the network entity. In accordance with various techniques described herein, improved techniques may enable a first UE to leverage reference signaling (e.g., a PDSCH DMRS) of a neighboring UE and use that reference signaling to measure a signal quality associated with a beam used by the neighboring UE. The first UE may report the measurements associated with the neighboring UE's serving beam to the network entity, and the network entity may determine whether an adjustment to the first UE's beam is needed. For instance, the network entity may determine whether the neighboring UE's beam, or in some cases, another beam, may be more suitable for the first UE. In some cases, the network entity may determine whether other adjustments or refinements to the first UE's beam may be required.

Aspects of the disclosure are initially described in the context of wireless communications systems. Aspects of the disclosure are additionally illustrated by and described with reference to configuration schemes and process flows. Aspects of the disclosure are further illustrated by and described with reference to apparatus diagrams, system diagrams, and flowcharts that relate to beam refinement using neighboring UE reference signaling.

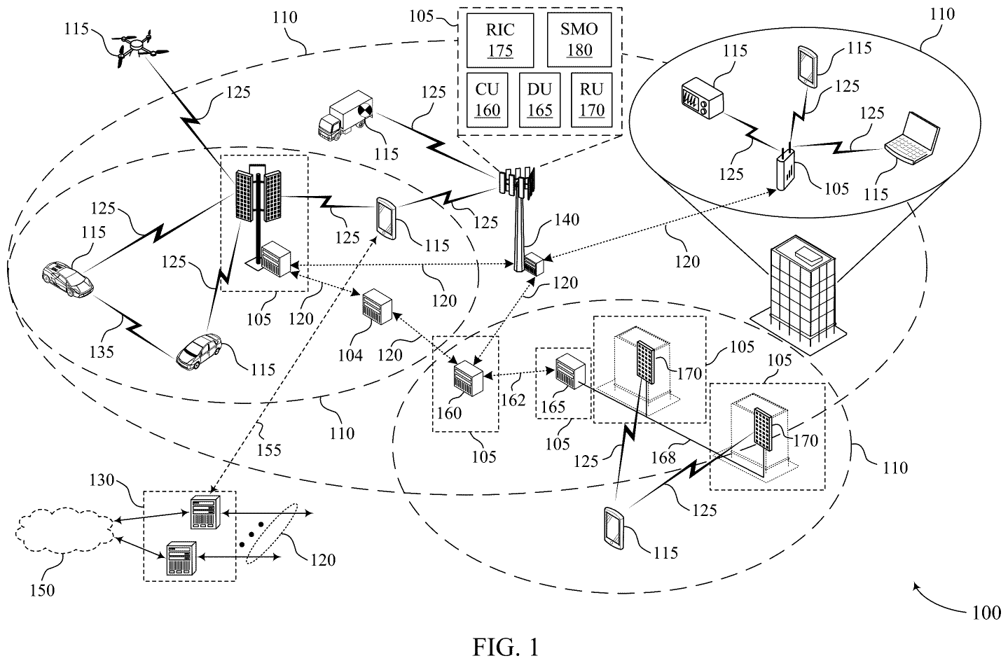

FIG. 1 shows an example of a wireless communications system 100 that supports beam refinement using neighboring UE reference signaling in accordance with one or more aspects of the present disclosure. The wireless communications system 100 may include one or more network entities 105, one or more UEs 115, and a core network 130. In some examples, the wireless communications system 100 may be an LTE network, an LTE-A network, an LTE-A Pro network, an NR network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, anode of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

In the case of the techniques described herein applied in the context of a disaggregated RAN architecture, one or more components of the disaggregated RAN architecture may be configured to support opportunistic beam refinement using PDSCH DMRSs of neighboring UEs as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHz, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a CSI-RS), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a transmitting device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest SNR, or otherwise acceptable signal quality based on listening according to multiple beam directions).

In some implementations, a first UE 115 may establish an initial connection with a network entity 105 based on SSBs broadcast by the network entity 105. The initial connection may be established via a first beam (e.g., a receive beam). Subsequently, the first UE 115 may receive, from the network entity 105, an indication of a resource allocation associated with a PDSCH for a second UE 115 (e.g., a second UE 115 that is in angular spatial proximity to the first UE 115) and an indication to measure a DMRS associated with the PDSCH for the second UE 115. Based on the indication, the first UE 115 may measure the DMRS associated with the second UE 115, and may report the measurements associated with the DMRS associated with the second UE 115 to the network entity 105. The network entity 105 may determine whether an adjustment to the beam associated with the first UE 115 may be needed. For instance, the network entity 105 may determine whether the beam associated with the second UE 115, or in some cases, a beam associated with a different UE 115, may be more suitable for the first UE 115. In some cases, the network entity 105 may determine whether other adjustments or refinements to the beam associated with the first UE 115 beam may be required.

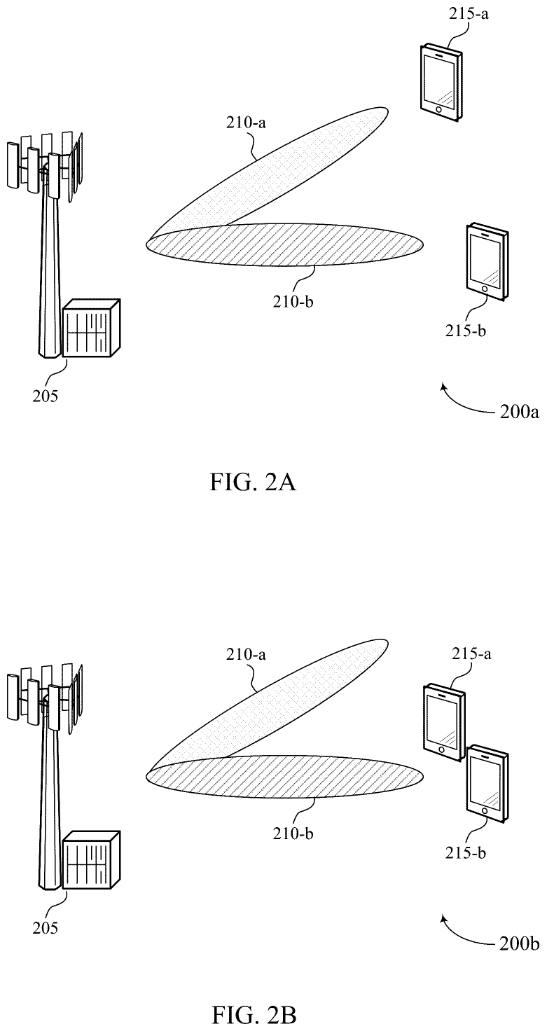

FIGS. 2A and 2B show examples of wireless communications system environments 200a and 200b that support beam refinement using neighboring UE reference signaling in accordance with one or more aspects of the present disclosure. In the example environment 200a of FIG. 2A, a network entity 205 (e.g., network entity 105 of FIG. 1) may be connected to one or more UEs 215 (e.g., UEs 115 of FIG. 1) for wireless communication via one or more corresponding beams 210. The one or more beams 210 may serve as the spatial or directional paths along which signals are transmitted from the network entity 205 to the one or more UEs 215. For instance, as shown, the network entity 205 may be connected to a first UE 215-a for wireless communication via a first beam 210-a, and to a second UE 215-b for wireless communication via a second beam 210-b.

To establish connections with the network entity 205, the first UE 215-a and the second UE 215-b may each search for and acquire initial beams (such as the first beam 210-a and second beam 210-b) from the network entity 205 to use for wireless communication. For instance, initially the first UE 215-a may use SSBs broadcast by one or more network entities 205 of one or more cells within a vicinity of the first UE 215-a to facilitate identification of and synchronization to potential serving cells within the vicinity of the first UE 215-a. Each of the SSBs may provide information about beams 210 transmitted by a network entity 205 of the associated cell. The first UE 215-a may utilize the information provided by the SSBs to select (such as based on a signal quality associated with each of the beams 210 or based on other factors) an appropriate beam 210 for initial communication with the corresponding network entity 205. Once a suitable beam 210 is selected, such as the first beam 210-a, the first UE 215-a may initiate the process of establishing an initial connection with the network entity 205, such as through a random access procedure, and the network entity 205 may communicate with the first UE 215-a via the selected first beam 210-a. That is, the first beam 210-a may serve as a spatial or directional path along which signals are transmitted from the network entity 205 to the first UE 215-a. The second UE 215-b may perform a similar process to select an initial beam 210, such as the second beam 210-b, for communicating with the network entity 205. In this case, the second beam 210-b may serve as a spatial or directional path along which signals are transmitted from the network entity 205 to the second UE 215-b.

In some cases, a beam initially selected for wireless communication may no longer be the most optimal beam (e.g., having a signal quality that is below a configured threshold, or having a signal quality that is less than a signal quality of one or more other beams). This may occur for various reasons, such as changed channel conditions or signal quality, movement of the UE 215, interference, environmental conditions, quality of service requirements, load balancing needs, and the like. For instance, as shown in the example environment 200b of FIG. 2B, the first UE 215-a may have moved from its initial position shown in environment 200a of FIG. 2A. In this example, the first UE 215-a may have moved to a position that is closer to the second UE 215-b. For instance, in the new position, the first UE 215-a may be in spatial angular proximity to the second UE 215-b. Since tracking may not be real-time, the first beam 210-a may still be serving the first UE 215-a in its new position, although the first beam 210-a may no longer be the most optimal beam for the network entity 205 to use to communicate with the first UE 215-a. In this case, a different beam may be more suitable (e.g., have a high signal quality or similar metric), or a refinement to the current first beam 210-a may be necessary, for the network entity 205 to maintain a reliable and good quality connection with the first UE 215-a in its new position. In accordance with aspects described herein, to determine whether an adjustment to a beam used for communication with the first UE 215-a may be necessary, the network entity 205 may periodically, aperiodically, or randomly direct the first UE 215-a to measure one or more metrics of DMRSs (or other reference signaling) associated with PDSCHs (or other downlink or sidelink signaling) being transmitted to one or more neighboring UEs, such as a UE in spatial angular proximity to the first UE 215-a. The network entity 205 may further instruct the first UE 215-a to report such measurements to the network entity 205, and the network entity 205 may use the reported measurements associated with the DMRSs of neighboring UEs to determine whether to adjust a beam associated with the first UE 215-a.

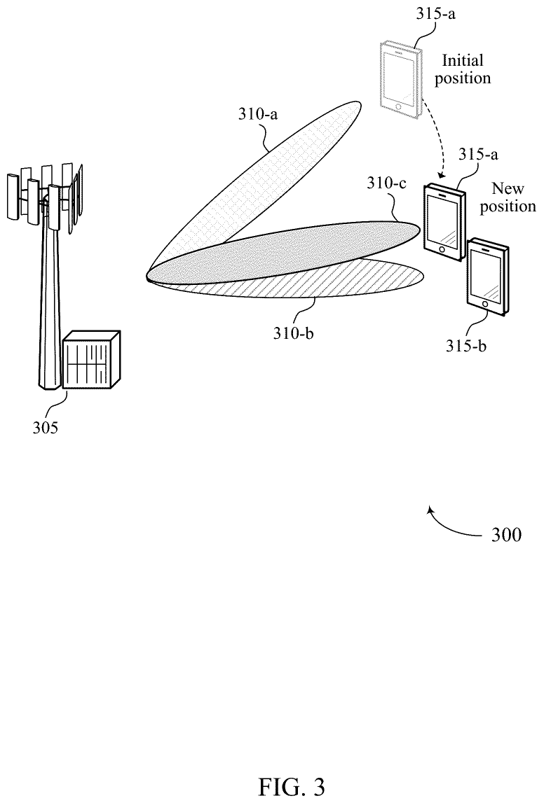

FIG. 3 shows an example of a wireless communications system environment 300 that supports beam refinement using neighboring UE reference signaling in accordance with one or more aspects of the present disclosure.

In the example environment 300, a network entity 305 (e.g., network entity 105 of FIG. 1) may be connected to one or more UEs 315 (e.g., UEs 115 of FIG. 1) for wireless communication via a one or more beams 310. The one or more beams 310 may serve as the spatial or directional paths along which signals are transmitted from the network entity 305 to the one or more UEs 315. For instance, as shown in environment 300, the network entity 305 may be connected to a first UE 315-a for wireless communication via a first beam 310-a, and to a second UE 315-b for wireless communication via a second beam 310-b. These initial connections may be established in a manner described with respect to FIG. 2A.

In some cases, after an initial connection is established between the network entity 305 and the UEs 315, an initially acquired beam may no longer be optimal for communication between the network entity 305 and one or more of the UEs 315. For example, changed channel conditions or signal quality, movement of the UE 315 interference, environmental conditions, quality of service requirements, load balancing needs, and the like may cause the initially acquired beam to no longer be optimal for reliable communication between the network entity 305 and one or more of the UEs 315. For instance, after acquiring the first beam 310-a, the first UE 315-a may move from its initial position to a new position. In the new position, the first beam 310-a may no longer be optimal for wireless communication between the network entity 305 and the first UE 315-a. In this case, a different beam may be more suitable, or a refinement to the current first beam 310-a may be necessary, for the network entity 305 to maintain a reliable and good quality connection with the first UE 315-a in its new position.

Accordingly, to determine whether an adjustment to a beam 310 used for communication with the first UE 315-a may be necessary, the network entity 305 may periodically, aperiodically, or randomly direct the first UE 315-a to measure one or more metrics of DMRSs associated with PDSCHs being transmitted to one or more neighboring UEs. For instance, the network entity 305 may determine one or more second UEs 315 in proximity, e.g., in a spatial angular proximity, to the first UE 315-a. Those UEs 315 that are in in spatial angular proximity to the first UE 315-a may be communicating with the network entity 305 via beams 310 that are angularly similar to the first beam 310-a serving the first UE 315-a. Accordingly, in some cases, when the network entity 305 transmits PDSCH unicast data to the one or more second UEs 315 in proximity to the first UE 315-a, the network entity 305 may additionally direct the first UE 315-a to measure one or more metrics of the DMRSs associated with PDSCHs transmitted to one or more second UEs 315.

For instance, the network entity 305 may transmit control signaling to the first UE 315-a including an indication of a PDSCH resource allocation that is for a different UE 315, such as a PDSCH resource allocation for the second UE 315-b. The control signaling may include an indication that the PDSCH resource allocation is for the different UE 315, such as for the second UE 315-b. The control signaling may further include an indication of the one or more metrics to be measured by the first UE 315-a. For instance, the control signaling may include an indication that the first UE 315-a is to use the DMRS transmitted to the second UE 315-b to measure a reference signal receive power (RSRP), a spectral efficiency (SPEF), one or more other metrics associated with the DMRS transmitted to the second UE 315-b, or any combination thereof. In some cases, the control signaling may include an indication to measure the one or more metrics within one or more allocated sub-bands, such as sub-band RSRP or SPEF. In some cases, the control signaling may further include an indication of precoding resource group (PRG) details associated with the second UE 315-b in order for the first UE 315-a to measure the one or more sub-band metrics.

The control signaling may further include an indication to report the measurements back to the network entity 305 via a beam management report. In some cases, the control signaling may indicate a trigger for such reporting. In some cases, the control signaling may indicate a partial resource allocation to be used by the first UE 315-a for reporting the beam management report.

In some cases, the control signaling may be sent by the network entity 305 to the first UE 315-a via downlink control information (DCI). For example, the aforementioned indications may be included in one or more fields of the DCI. In some cases, the control signaling may be sent by the network entity 305 to the first UE 315-a via, a MAC-control element (MAC-CE) or other control signaling. In some cases, the control signaling may be sent by the network entity 305 to the first UE 315-a via a combination of DCI, MAC-CE, or other control signaling.

Upon receiving the control signaling including the indication of the PDSCH resource allocation for the second UE 315-b, the first UE 315-a may decode the control signaling (e.g., decode the DCI) to determine a location within the resource allocation of one or more resource blocks or resource elements allocated for the DMRS, a quantity of DMRS ports, or both. The first UE 315-a may use the DMRS associated with the second UE 315-b to measure the one or more metrics, e.g., RSRP or SPEF, indicated in the control signaling and may report the measurements to the network entity 305 via a beam management report. The first UE 315-a may transmit the beam management report to the network entity 305 via uplink control signaling, such as via uplink control information (UCI) or other uplink control signaling or a combination thereof. In some cases, the beam management report may be transmitted using the partial resource allocation indicated by the network entity 305 in the control signaling, e.g., in the DCI.

The network entity 305 may receive the beam management report from the first UE 315-a reporting the measurements associated with the DMRS of the second UE 315-b and may use the reported measurements to determine whether to adjust a beam associated with the first UE 315-a. For instance, the network entity 305 may compare the reported measurements received from the first UE 315-a to previous measurements performed on the first beam 310-a associated with the first UE 315-a, the second beam 310-b associated with the second UE 315-b, or one or more other beams 310 associated with different UEs 315 in proximity (e.g., a spatial angular proximity) to the first UE 315-a. For example, the network entity 305 may compare the reported measurements to previous measurements such as SSB measurements, phase 2 (P2) beam management CSI-RS measurements, other measurements on one or more other beams 310 acquired using DMRSs unicast to other UEs 315, or a combination thereof.

The comparison of the reported measurements (e.g., the measurements based on the DMRS associated with the second UE 315-b) to previous measurements may assist the network entity 305 in determining whether to adjust a beam associated with the first UE 315-a. For instance, in some cases, based on the comparison of the reported measurements to the previous measurements, the network entity 305 may determine that the beam associated with the UE 315 whose DMRS was used for the measurements by the first UE 315-a is an optimal beam for wireless communication with the first UE 315-a in its new position. For example, the network entity 305 may determine that the second beam 310-b associated with the second UE 315-b is an optimal beam for wireless communication with the first UE 315-a in its new position. In such cases, the network entity 305 may cause, instruct, or otherwise notify the first UE 315-a to switch from the first beam 310-a to the second beam 310-b.

In some cases, based on the comparison of the reported measurements to the previous measurements, the network entity 305 may determine that a different beam, such as beam 310-c, should be directed to the first UE 315-a. In some cases, the different beam 310-c may be a newly configured beam or may be a beam associated with a different UE 315 (not illustrated). In some cases, the network entity 305 may further align the different beam 310-c with a position of the first UE 315-a. The network entity 305 may cause, instruct, or otherwise notify the first UE 315-a to switch from the first beam 310-a to the different beam 310-c.

In some cases, based on the comparison of the reported measurements to the previous measurements, the network entity 305 may determine that the current beam associated with the first UE 315-a, such as the first beam 310-a, should be adjusted to be directed to the first UE 315-a in its new location. For example, the network entity 305 may determine to adjust one or more beamforming weights or parameters associated with the first beam 310-a, to adjust a phase or amplitude of antenna elements associated with the network entity 305, to adjust modulation and coding schemes, to adjust a transmit power, to make other adjustments, or any combination thereof in order to focus the beam more precisely on the first UE 315-a. In such cases, the network entity 305 may make the determined adjustments.

In some cases, based on the comparison of the reported measurements to the previous measurements, the network entity 305 may determine that no adjustment is necessary to maintain reliable wireless communication with the first UE 315-a in its new position. Further, because the network entity 305 may periodically, aperiodically, or randomly direct the first UE 315-a to measure the one or more metrics of DMRSs associated with one or more UEs 315 in proximity to the first UE 315-a, it may be the case that the first UE 315-a has not moved from its initial or previous position and, in such cases, the network entity 305 may determine that no adjustment is necessary to maintain reliable wireless communication with the first UE 315-a.

Accordingly, the described techniques of leveraging the DMRSs directed to other UEs 315 in a spatial angular proximity to a first UE 315-a may provide improved beam management at a network entity 305 without wasting spectrum using CSI-RS for beam management, which in turn may result in more efficient utilization of wireless resources.

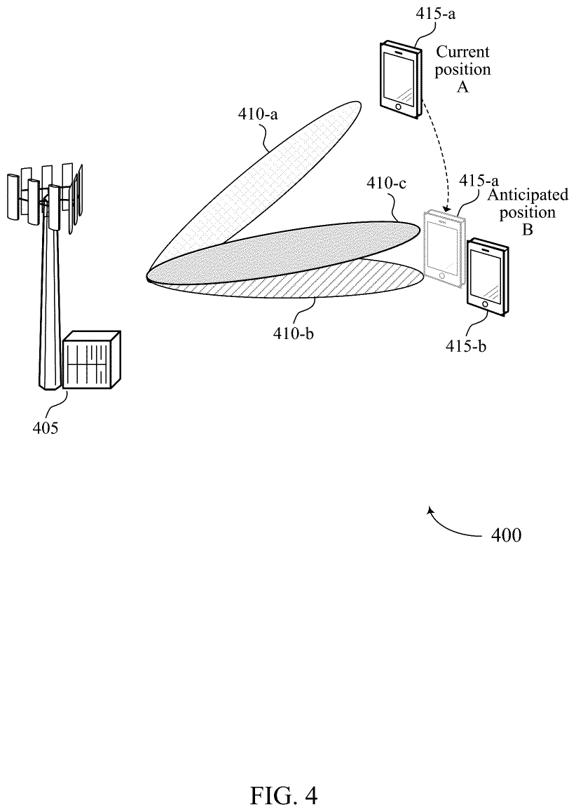

FIG. 4 shows an example of a wireless communications system environment 400 that supports beam refinement using neighboring UE reference signaling in accordance with one or more aspects of the present disclosure.

In the example environment 400, a network entity 405 (e.g., network entity 105 of FIG. 1) may be connected to one or more UEs 415 (e.g., UEs 115 of FIG. 1) for wireless communication via a one or more beams 410. The one or more beams 410 may serve as the spatial or directional paths along which signals are transmitted from the network entity 405 to the one or more UEs 415. For instance, as shown in environment 400, the network entity 405 may be connected to a first UE 415-a for wireless communication via a first beam 410-a, and to a second UE 415-b for wireless communication via a second beam 410-b. These initial connections may be established in a manner described with respect to FIG. 2A.

In some cases, after an initial connection is established between the network entity 405 and the UEs 415, one or more of the UEs 415 may determine that a currently serving beam 410 may not remain an optimal beam 410 for the UE 415 because the UE 415 may anticipate that it will move outside of a range of a spatial direction or path of the currently serving beam 410. For instance, the first UE 415-a may be aware that it is moving in a direction that is outside of the range of the spatial path of the first beam 410-a, and may determine that the first beam 410-a may likely not be the most optimal beam for communication with the network entity 405. Accordingly, in such cases, the first UE 415-a may assist the network entity 405 in directing a more appropriate beam to the first UE 415-a.

For instance, in some cases, the first UE 415-a may suggest or recommend, to the network entity 405, a spatial direction from which to receive a unicast DMRS associated with one or more second UEs 415 in proximity (e.g., in spatial angular proximity) to the first UE 415-a. That is, because the first UE 415-a may know more precisely than the network entity 305 what the first UE's 415-a position or direction of movement is, the first UE 415-a may assist the network entity 305 in the beam management process by requesting that the network entity 405 transmit, to the first UE 415, control signaling (such as described with respect to FIG. 3) indicating a resource allocation for a unicast DMRS for a second UE 415-b associated with a beam from a specific spatial direction or having a specific spatial orientation.

For instance, if the UE 415-a knows that it is moving in a particular direction or to an anticipated position or location, the UE 415-a may request that the network entity 405 direct the first UE 415-a to measure one or more metrics (e.g., RSRP or SPEF) using a DMRS associated with a beam oriented in the direction the first UE 415-a is moving or oriented towards the anticipated position of the first UE 415-a. For instance, the first UE 415-a may know that it is moving from a Current position A to an Anticipated position B and request that the network entity 405 direct the first UE 415-a to measure one or more metrics using a DMRS associated with a beam oriented towards Anticipated position B. In this case, the first UE 415-a may transmit a message to the network entity 405 recommending a spatial direction from which to receive a DMRS from one or more second UEs 415. Accordingly, in some cases, the first UE 415-a may transmit the message in response to movement detected at the first UE 415-a, a change in a location or position of the first UE 415-a, or a change in direction or orientation of the first UE 415-a. The message may be transmitted via uplink control signaling, such as UCI or other control signaling, to the network entity 405 including the recommended spatial direction.

Responsive to receiving the message indicating the recommended spatial direction, the network entity 405 may transmit, to the first UE 415, control signaling indicating a resource allocation for unicast DMRSs for one or more other UEs 415 associated with a beam that may be oriented in the direction where the UE is heading or towards the anticipated position of the first UE 415-a. For instance, the network entity 405 may transmit, to the first UE 415-a, control signaling indicating a resource allocation for a unicast DMRS for the second UE 415-b that may be associated with beam 410-b that is oriented towards the Anticipated position B. The first UE 415-a may receive the control signaling and may measure one or more metrics using the unicast DMRS and report the measurements back to the network entity 405 such as described with respect to FIG. 3 and the network entity 405 may determine whether to adjust a beam associated with the first UE 415-a. For instance, the network entity 405 may cause, instruct, or notify the first UE 415-a to switch from the first beam 410-a to the second beam 410-b. In some cases, the network entity 405 may determine that there are no beams serving other UEs in the direction the first UE 415-a is heading or in an anticipated position of the first UE 415-a. In such cases, the network entity 405 may determine to configure and direct and a new beam, such as new beam 410-c, in the direction of to the first UE 415-a.

In some cases, rather than recommending a particular spatial direction from which to receive a unicast DMRS for another UE for measuring by the first UE 415-a, the first UE 415-a may instead request that the network entity 405 direct a specific beam 410 at the first UE 415-a, such as using a CSI-RS procedure or in the PDSCH for the first UE 415-a. For instance, the first UE 415-a may transmit a message to the network entity 405 recommending a specific beam 410 to be directed at first UE 415-a. In some cases, the first UE 415-a may transmit the message in response to movement detected at the first UE 415-a, a change in a location or position of the first UE 415-a, or a change in direction or orientation of the first UE 415-a. The first UE 415-a may transmit the message via uplink control signaling, such as UCI or other control signaling, to the network entity 405 including the recommended specific beam 410.

Responsive to receiving the message indicating the recommended specific beam 410, the network entity 405 may determine whether to direct the recommended specific beam to the first UE 415-a. If the network entity 405 determines to direct the recommended specific beam 410 to the first UE 415-a, the network entity 405 may cause, instruct, or notify the first UE 415-a to switch from the first beam 410-a to the recommended specific 410.

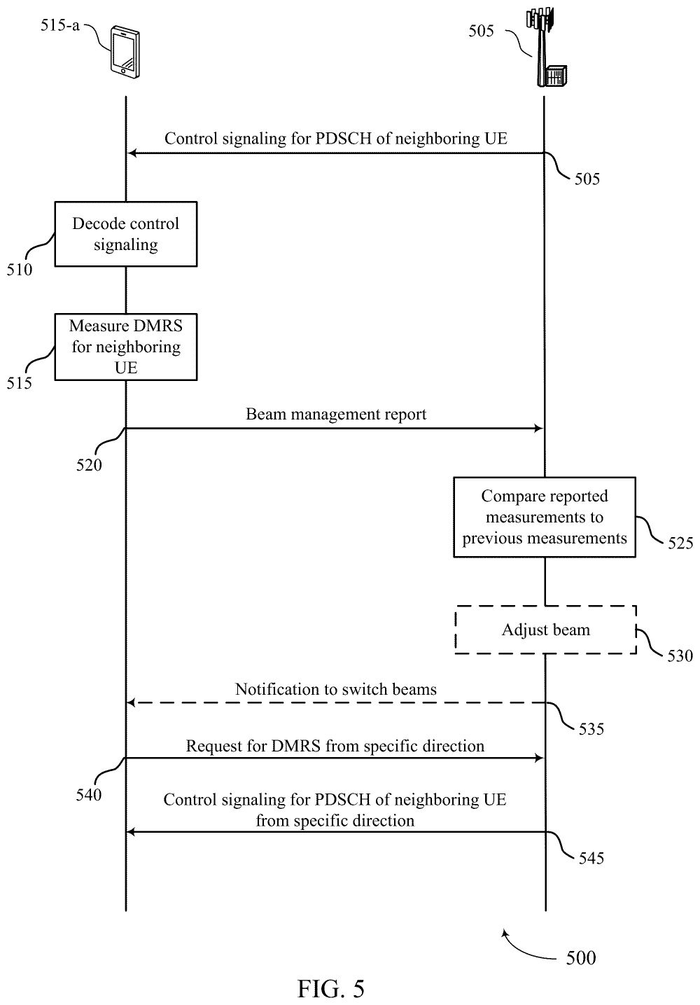

FIG. 5 shows an example of a process flow 500 that supports beam refinement using neighboring UE reference signaling in accordance with one or more aspects of the present disclosure. In some examples, process flow 500 may implement aspects of wireless communications system 100. Process flow 500 may be implemented by a first UE 515-a and a network entity 505 as described herein. In the following description of the process flow 500, the communications between the first UE 515-a and the network entity 505 may be transmitted in a different order than the example order shown, or the operations performed by the first UE 515-a and network entity 505 may be performed in different orders or at different times. Some operations may also be omitted from the process flow 500, and other operations may be added to the process flow 500.

In some examples, the operations illustrated in process flow 500 may be performed by hardware (e.g., including circuitry, processing blocks, logic components, and other components), code (e.g., software or firmware) executed by a processor, or any combination thereof. Alternative examples of the following may be implemented, where some steps are performed in a different order than described or are not performed at all. In some cases, steps may include additional features not mentioned below, or further steps may be added.

At 505, network entity 505 may transmit, to the first UE 515-a, control signaling including an indication of a PDSCH resource allocation that is for a different UE, such as a PDSCH resource allocation for a neighboring UE, and an indication to measure a DMRS associated with the PDSCH. For instance, the neighboring UE may be a UE that is in spatial angular proximity to the first UE 515-a. The control signaling may include an indication of one or more metrics to be measured using the DMRS, such as a RSRP, a SPEF, one or more other metrics associated with the DMRS for the neighboring UE, or any combination thereof. In some cases, the control signaling may include an indication to measure the one or more metrics within one or more allocated sub-bands, such as sub-band RSRP or SPEF. In some cases, the control signaling may further include an indication of PRG details associated with the neighboring UE to support measuring the one or more sub-band metrics. The control signaling may include an indication to report the measurements back to the network entity 505 via a beam management report. In some cases, the control signaling may indicate a trigger for such reporting. In some cases, the control signaling may indicate a partial resource allocation to be used by the first UE 515-a for reporting the beam management report. The control signaling may be sent by the network entity 505 to the first UE 515-a via DCI, a MAC-CE, other control signaling, or a combination thereof.

At 510, the first UE 515-a may receive and decode the control signaling (e.g., by decoding the DCI) to determine a location, within the resource allocation for the neighboring UE, of the DMRS, a quantity of DMRS ports, or both.

At 515, the first UE 515-a may use the DMRS associated with the neighboring UE to measure the one or more metrics, e.g., RSRP or SPEF, indicated in the control signaling.

At 520, the first UE 515-a may transmit, to the network entity 505, a beam management report including the measurements associated with the DMRS associated with the neighboring UE. In some cases, the beam management report may be transmitted using the partial resource allocation indicated by the network entity 505 in the control signaling. The beam management report may be transmitted to the network entity 505 via uplink control signaling, such as via UCI or other uplink control signaling or a combination thereof.

At 525, in response to receiving the beam management report, the network entity 505 may compare the reported measurements to previous measurements performed on a beam currently serving the first UE 515-a, a beam serving the neighboring UE (such as a beam associated with the DMRS measured by the first UE 515-a in step 515), or one or more other beams associated with other UEs in proximity (e.g., spatial angular proximity) to the first UE 515-a. For example, the network entity 505 may compare the reported measurements to previous measurements such as SSB measurements, P2 beam management CSI-RS measurements, other measurements on one or more other beams acquired using DMRSs unicast to other UEs in proximity (e.g., spatial angular proximity) to the first UE 515-a, or a combination thereof.

At 530, the network entity 505 may determine whether to adjust a beam associated with the first UE 515-a. For instance, in some cases, based on the comparison of the reported measurements to the previous measurements, the network entity 505 may determine that the beam associated with the neighboring UE whose DMRS was used for the measurements is an optimal beam for wireless communication with the first UE 515-a. In some cases, based on the comparison of the reported measurements to the previous measurements, the network entity 505 may determine that a different beam (e.g., different from the beam associated with the measured DMRS) should be directed to the first UE 515-a. In some cases, the different beam may be a newly configured beam or may be a beam associated with another neighboring UE. In some cases, based on the comparison of the reported measurements to the previous measurements, the network entity 505 may determine that the beam currently serving the first UE 515-a should be adjusted to be more precisely directed to the first UE 515-a. The network entity 505 may make the determined adjustments. In some cases, based on the comparison of the reported measurements to the previous measurements, the network entity 505 may determine that no adjustment is necessary.

At 535, if the network entity 530 determines to adjust a beam currently serving the first UE 515-a to a different beam, the network entity 530 may transmit, to the first UE 515-a, a message including a notification for the first UE 515-a to switch from a first beam to the different beam.

At 540, in some cases, the first UE 515-a may transmit, to the network entity 505, a request or recommendation to receive a DMRS associated with a neighboring UE from a particular spatial direction. In some cases, the request may be for a specific beam to be directed to the first UE 515-a. The request may be transmitted to the network entity 505 via uplink control signaling, such as via UCI, other uplink control signaling, or a combination thereof.

At 545, in response to receiving the request or recommendation for a DMRS associated with a neighboring UE from a particular spatial direction, the network entity 505 may transmit, to the first UE 515-a, second control signaling including an indication of a second PDSCH resource allocation that is for a different UE, such as for a UE positioned in the indicated spatial direction. The second control signaling may additionally include an indication for the first UE 515-a to measure a DMRS associated with the second PDSCH. The second control signaling may be similar to and received in a similar manner as the control signaling received at 505.

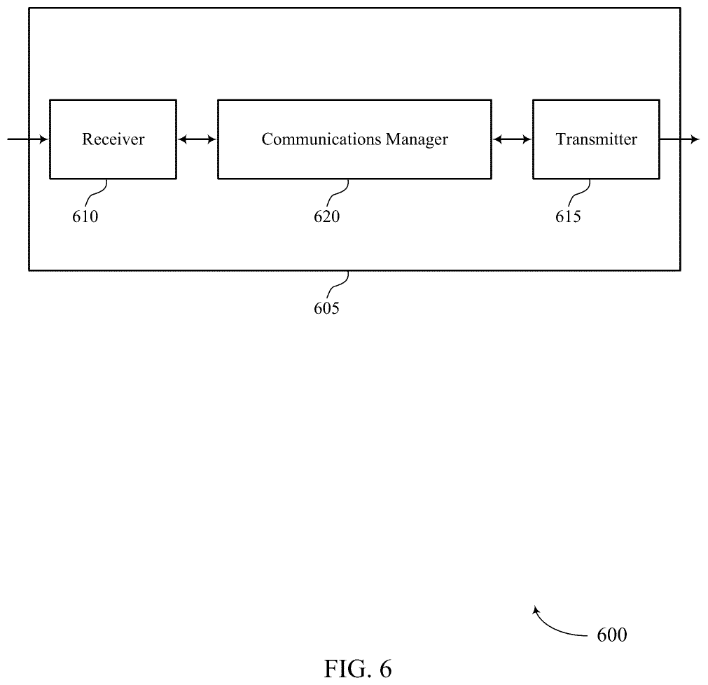

FIG. 6 shows a block diagram 600 of a device 605 that supports beam refinement using neighboring UE reference signaling in accordance with one or more aspects of the present disclosure. The device 605 may be an example of aspects of a UE 115 as described herein. The device 605 may include a receiver 610, a transmitter 615, and a communications manager 620. The device 605, or one or more components of the device 605 (e.g., the receiver 610, the transmitter 615, and the communications manager 620), may include at least one processor, which may be coupled with at least one memory, to, individually or collectively, support or enable the described techniques. Each of these components may be in communication with one another (e.g., via one or more buses).

The receiver 610 may provide a means for receiving information such as packets, user data, control information, or any combination thereof associated with various information channels (e.g., control channels, data channels, information channels related to beam refinement using neighboring UE reference signaling). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to opportunistic beam refinement using PDSCH DMRSs of neighboring UEs). In some examples, the transmitter 615 may be co-located with a receiver 610 in a transceiver module. The transmitter 615 may utilize a single antenna or a set of multiple antennas.

The communications manager 620, the receiver 610, the transmitter 615, or various combinations thereof or various components thereof may be examples of means for performing various aspects of beam refinement using neighboring UE reference signaling as described herein. For example, the communications manager 620, the receiver 610, the transmitter 615, or various combinations or components thereof may be capable of performing one or more of the functions described herein.

In some examples, the communications manager 620, the receiver 610, the transmitter 615, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 620, the receiver 610, the transmitter 615, or various combinations or components thereof may be implemented in code (e.g., as communications management software or firmware) executed by at least one processor. If implemented in code executed by at least one processor, the functions of the communications manager 620, the receiver 610, the transmitter 615, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 620 may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications in accordance with examples as disclosed herein. For example, the communications manager 620 is capable of, configured to, or operable to support a means for receiving control signaling including an indication of a resource allocation associated with a PDSCH for a second UE and an indication to measure a DMRS associated with the PDSCH for the second UE. The communications manager 620 is capable of, configured to, or operable to support a means for measuring, based on receiving the control signaling, the DMRS associated with the PDSCH for the second UE. The communications manager 620 is capable of, configured to, or operable to support a means for transmitting, to a network entity and based on measuring the DMRS associated with the PDSCH for the second UE, signaling including a beam management report.

By including or configuring the communications manager 620 in accordance with examples as described herein, the device 605 (e.g., at least one processor controlling or otherwise coupled with the receiver 610, the transmitter 615, the communications manager 620, or a combination thereof) may support techniques for improved reliability in wireless communications and more efficient utilization of communication resources.

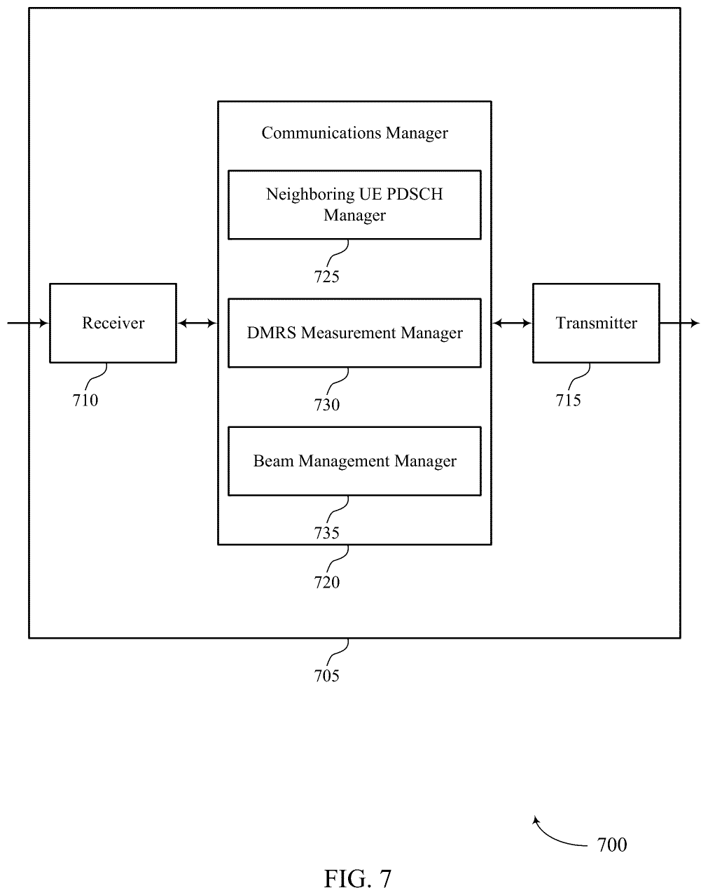

FIG. 7 shows a block diagram 700 of a device 705 that supports beam refinement using neighboring UE reference signaling in accordance with one or more aspects of the present disclosure. The device 705 may be an example of aspects of a device 605 or a UE 115 as described herein. The device 705 may include a receiver 710, a transmitter 715, and a communications manager 720. The device 705, or one of more components of the device 705 (e.g., the receiver 710, the transmitter 715, and the communications manager 720), may include at least one processor, which may be coupled with at least one memory, to support the described techniques. Each of these components may be in communication with one another (e.g., via one or more buses).

The receiver 710 may provide a means for receiving information such as packets, user data, control information, or any combination thereof associated with various information channels (e.g., control channels, data channels, information channels related to opportunistic beam refinement using PDSCH DMRSs of neighboring UEs). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to opportunistic beam refinement using PDSCH DMRSs of neighboring UEs). In some examples, the transmitter 715 may be co-located with a receiver 710 in a transceiver module. The transmitter 715 may utilize a single antenna or a set of multiple antennas.

The device 705, or various components thereof, may be an example of means for performing various aspects of opportunistic beam refinement using PDSCH DMRSs of neighboring UEs as described herein. For example, the communications manager 720 may include a neighboring UE PDSCH manager 725, a DMRS measurement manager 730, a beam management manager 735, or any combination thereof. The communications manager 720 may be an example of aspects of a communications manager 620 as described herein. In some examples, the communications manager 720, or various components thereof, may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communications in accordance with examples as disclosed herein. The neighboring UE PDSCH manager 725 is capable of, configured to, or operable to support a means for receiving control signaling including an indication of a resource allocation associated with a PDSCH for a second UE and an indication to measure a DMRS associated with the PDSCH for the second UE. The DMRS measurement manager 730 is capable of, configured to, or operable to support a means for measuring, based on receiving the control signaling, the DMRS associated with the PDSCH for the second UE. The beam management manager 735 is capable of, configured to, or operable to support a means for transmitting, to a network entity and based on measuring the DMRS associated with the PDSCH for the second UE, signaling including a beam management report.

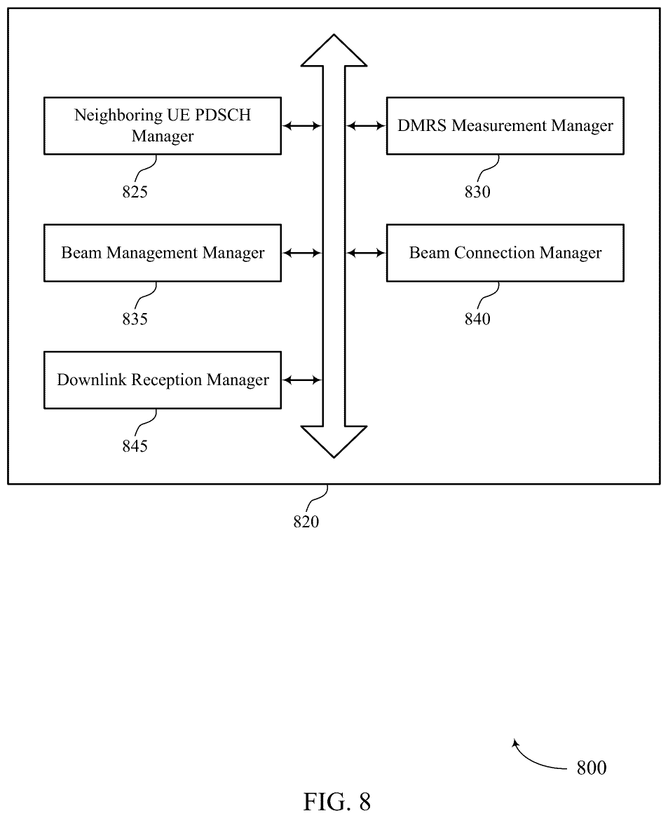

FIG. 8 shows a block diagram 800 of a communications manager 820 that supports beam refinement using neighboring UE reference signaling in accordance with one or more aspects of the present disclosure. The communications manager 820 may be an example of aspects of a communications manager 620, a communications manager 720, or both, as described herein. The communications manager 820, or various components thereof, may be an example of means for performing various aspects of opportunistic beam refinement using PDSCH DMRSs of neighboring UEs as described herein. For example, the communications manager 820 may include a neighboring UE PDSCH manager 825, a DMRS measurement manager 830, a beam management manager 835, a beam connection manager 840, a downlink reception manager 845, or any combination thereof. Each of these components, or components or subcomponents thereof (e.g., one or more processors, one or more memories), may communicate, directly or indirectly, with one another (e.g., via one or more buses).

The communications manager 820 may support wireless communications in accordance with examples as disclosed herein. The neighboring UE PDSCH manager 825 is capable of, configured to, or operable to support a means for receiving control signaling including an indication of a resource allocation associated with a PDSCH for a second UE and an indication to measure a DMRS associated with the PDSCH for the second UE. The DMRS measurement manager 830 is capable of, configured to, or operable to support a means for measuring, based on receiving the control signaling, the DMRS associated with the PDSCH for the second UE. The beam management manager 835 is capable of, configured to, or operable to support a means for transmitting, to a network entity and based on measuring the DMRS associated with the PDSCH for the second UE, signaling including a beam management report.

In some examples, the control signaling further includes an indication that the resource allocation is associated with the second UE.

In some examples, the control signaling further includes an indication of one or more metrics to measure.

In some examples, measuring the DMRS includes measuring, using the DMRS, the one or more metrics.

In some examples, the control signaling further includes an indication to measure the one or more metrics within each allocated sub-band.

In some examples, to support measuring the DMRS, the DMRS measurement manager 830 is capable of, configured to, or operable to support a means for measuring, using the DMRS, the one or more metrics within each allocated sub-band.

In some examples, the one or more metrics include a reference signal received power, a spectral efficiency, or a combination thereof.

In some examples, the DMRS measurement manager 830 is capable of, configured to, or operable to support a means for decoding the control signaling to determine: one or more resource blocks within the resource allocation including the DMRS, and a quantity of DMRS ports associated with the DMRS.

In some examples, the control signaling further includes an indication to transmit, to the network entity, the signaling including the beam management report.

In some examples, the control signaling further includes an indication of a partial resource allocation to use for transmitting the signaling including the beam management report.

In some examples, the control signaling is received in downlink control information or a medium access control-control element.

In some examples, the DMRS includes a unicast DMRS.

In some examples, the beam connection manager 840 is capable of, configured to, or operable to support a means for establishing, prior to receiving the control signaling and based on a synchronization signal block, a connection with the network entity via a first directional beam.

In some examples, the beam connection manager 840 is capable of, configured to, or operable to support a means for receiving, from the network entity and responsive to transmission of the signaling including the beam management report, a message notifying the first UE to switch from a first directional beam to a second directional beam.

In some examples, the second directional beam is associated with the second UE.

In some examples, the second directional beam is a directional beam associated with a third UE.

In some examples, the second directional beam is a newly-configured directional beam.

In some examples, the downlink reception manager 845 is capable of, configured to, or operable to support a means for receiving, from the network entity, a subsequent data transmission via the second directional beam.

In some examples, the second UE is in spatial angular proximity to the first UE.

In some examples, the beam management manager 835 is capable of, configured to, or operable to support a means for transmitting, to the network entity, second signaling recommending a spatial direction of a directional beam to be associated with the first UE, a different directional beam to be associated with the first UE, or a combination thereof.

In some examples, the second signaling is transmitted based on movement detected at the first UE, a changed location of the first UE, or a changed direction of the first UE.

In some examples, the second signaling indicates a direction of movement of the first UE.

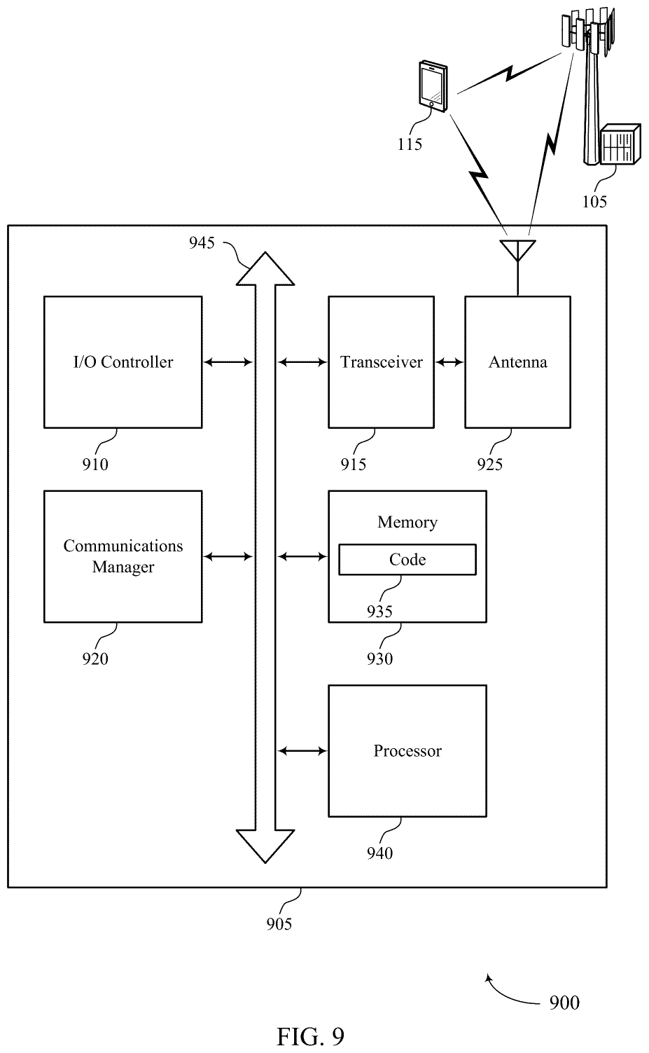

FIG. 9 shows a diagram of a system 900 including a device 905 that supports beam refinement using neighboring UE reference signaling in accordance with one or more aspects of the present disclosure. The device 905 may be an example of or include the components of a device 605, a device 705, or a UE 115 as described herein. The device 905 may communicate (e.g., wirelessly) with one or more network entities 105, one or more UEs 115, or any combination thereof. The device 905 may include components for bi-directional voice and data communications including components for transmitting and receiving communications, such as a communications manager 920, an input/output (I/O) controller 910, a transceiver 915, an antenna 925, at least one memory 930, code 935, and at least one processor 940. These components may be in electronic communication or otherwise coupled (e.g., operatively, communicatively, functionally, electronically, electrically) via one or more buses (e.g., a bus 945).

The I/O controller 910 may manage input and output signals for the device 905. The I/O controller 910 may also manage peripherals not integrated into the device 905. In some cases, the I/O controller 910 may represent a physical connection or port to an external peripheral. In some cases, the I/O controller 910 may utilize an operating system such as iOS®, ANDROID®, MS-DOS®, MS-WINDOWS®, OS/2®, UNIX®, LINUX®, or another known operating system. Additionally or alternatively, the I/O controller 910 may represent or interact with a modem, a keyboard, a mouse, a touchscreen, or a similar device. In some cases, the I/O controller 910 may be implemented as part of one or more processors, such as the at least one processor 940. In some cases, a user may interact with the device 905 via the I/O controller 910 or via hardware components controlled by the I/O controller 910.

In some cases, the device 905 may include a single antenna 925. However, in some other cases, the device 905 may have more than one antenna 925, which may be capable of concurrently transmitting or receiving multiple wireless transmissions. The transceiver 915 may communicate bi-directionally, via the one or more antennas 925, wired, or wireless links as described herein. For example, the transceiver 915 may represent a wireless transceiver and may communicate bi-directionally with another wireless transceiver. The transceiver 915 may also include a modem to modulate the packets, to provide the modulated packets to one or more antennas 925 for transmission, and to demodulate packets received from the one or more antennas 925. The transceiver 915, or the transceiver 915 and one or more antennas 925, may be an example of a transmitter 615, a transmitter 715, a receiver 610, a receiver 710, or any combination thereof or component thereof, as described herein.

The at least one memory 930 may include random access memory (RAM) and read-only memory (ROM). The at least one memory 930 may store computer-readable, computer-executable code 935 including instructions that, when executed by the at least one processor 940, cause the device 905 to perform various functions described herein. The code 935 may be stored in a non-transitory computer-readable medium such as system memory or another type of memory. In some cases, the code 935 may not be directly executable by the at least one processor 940 but may cause a computer (e.g., when compiled and executed) to perform functions described herein. In some cases, the at least one memory 930 may contain, among other things, a basic I/O system (BIOS) which may control basic hardware or software operation such as the interaction with peripheral components or devices.

The at least one processor 940 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the at least one processor 940 may be configured to operate a memory array using a memory controller. In some other cases, a memory controller may be integrated into the at least one processor 940. The at least one processor 940 may be configured to execute computer-readable instructions stored in a memory (e.g., the at least one memory 930) to cause the device 905 to perform various functions (e.g., functions or tasks supporting opportunistic beam refinement using PDSCH DMRSs of neighboring UEs). For example, the device 905 or a component of the device 905 may include at least one processor 940 and at least one memory 930 coupled with or to the at least one processor 940, the at least one processor 940 and at least one memory 930 configured to perform various functions described herein. In some examples, the at least one processor 940 may include multiple processors and the at least one memory 930 may include multiple memories. One or more of the multiple processors may be coupled with one or more of the multiple memories, which may, individually or collectively, be configured to perform various functions herein. In some examples, the at least one processor 940 may be a component of a processing system, which may refer to a system (such as a series) of machines, circuitry (including, for example, one or both of processor circuitry (which may include the at least one processor 940) and memory circuitry (which may include the at least one memory 930)), or components, that receives or obtains inputs and processes the inputs to produce, generate, or obtain a set of outputs. The processing system may be configured to perform one or more of the functions described herein. As such, the at least one processor 940 or a processing system including the at least one processor 940 may be configured to, configurable to, or operable to cause the device 905 to perform one or more of the functions described herein. Further, as described herein, being “configured to,” being “configurable to,” and being “operable to” may be used interchangeably and may be associated with a capability, when executing code stored in the at least one memory 930 or otherwise, to perform one or more of the functions described herein.

The communications manager 920 may support wireless communications in accordance with examples as disclosed herein. For example, the communications manager 920 is capable of, configured to, or operable to support a means for receiving control signaling including an indication of a resource allocation associated with a PDSCH for a second UE and an indication to measure a DMRS associated with the PDSCH for the second UE. The communications manager 920 is capable of, configured to, or operable to support a means for measuring, based on receiving the control signaling, the DMRS associated with the PDSCH for the second UE. The communications manager 920 is capable of, configured to, or operable to support a means for transmitting, to a network entity and based on measuring the DMRS associated with the PDSCH for the second UE, signaling including a beam management report.

By including or configuring the communications manager 920 in accordance with examples as described herein, the device 905 may support techniques for improved communication reliability and more efficient utilization of communication resources.

In some examples, the communications manager 920 may be configured to perform various operations (e.g., receiving, monitoring, transmitting) using or otherwise in cooperation with the transceiver 915, the one or more antennas 925, or any combination thereof. Although the communications manager 920 is illustrated as a separate component, in some examples, one or more functions described with reference to the communications manager 920 may be supported by or performed by the at least one processor 940, the at least one memory 930, the code 935, or any combination thereof. For example, the code 935 may include instructions executable by the at least one processor 940 to cause the device 905 to perform various aspects of opportunistic beam refinement using PDSCH DMRSs of neighboring UEs as described herein, or the at least one processor 940 and the at least one memory 930 may be otherwise configured to, individually or collectively, perform or support such operations.

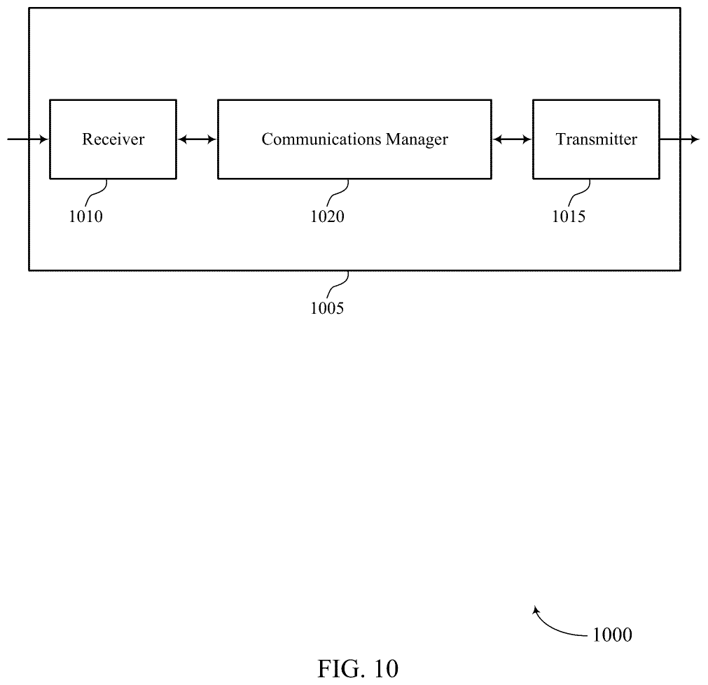

FIG. 10 shows a block diagram 1000 of a device 1005 that supports beam refinement using neighboring UE reference signaling in accordance with one or more aspects of the present disclosure. The device 1005 may be an example of aspects of a network entity 105 as described herein. The device 1005 may include a receiver 1010, a transmitter 1015, and a communications manager 1020. The device 1005, or one or more components of the device 1005 (e.g., the receiver 1010, the transmitter 1015, and the communications manager 1020), may include at least one processor, which may be coupled with at least one memory, to, individually or collectively, support or enable the described techniques. Each of these components may be in communication with one another (e.g., via one or more buses).

The receiver 1010 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1005. In some examples, the receiver 1010 may support obtaining information by receiving signals via one or more antennas. Additionally, or alternatively, the receiver 1010 may support obtaining information by receiving signals via one or more wired (e.g., electrical, fiber optic) interfaces, wireless interfaces, or any combination thereof.

The transmitter 1015 may provide a means for outputting (e.g., transmitting, providing, conveying, sending) information generated by other components of the device 1005. For example, the transmitter 1015 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1015 may support outputting information by transmitting signals via one or more antennas. Additionally, or alternatively, the transmitter 1015 may support outputting information by transmitting signals via one or more wired (e.g., electrical, fiber optic) interfaces, wireless interfaces, or any combination thereof. In some examples, the transmitter 1015 and the receiver 1010 may be co-located in a transceiver, which may include or be coupled with a modem.

The communications manager 1020, the receiver 1010, the transmitter 1015, or various combinations thereof or various components thereof may be examples of means for performing various aspects of opportunistic beam refinement using PDSCH DMRSs of neighboring UEs as described herein. For example, the communications manager 1020, the receiver 1010, the transmitter 1015, or various combinations or components thereof may be capable of performing one or more of the functions described herein.

In some examples, the communications manager 1020, the receiver 1010, the transmitter 1015, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 1020, the receiver 1010, the transmitter 1015, or various combinations or components thereof may be implemented in code (e.g., as communications management software or firmware) executed by at least one processor. If implemented in code executed by at least one processor, the functions of the communications manager 1020, the receiver 1010, the transmitter 1015, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 1020 may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communication in accordance with examples as disclosed herein. For example, the communications manager 1020 is capable of, configured to, or operable to support a means for transmitting, to a first UE, control signaling including an indication of a resource allocation associated with a PDSCH for a second UE and an indication to measure a DMRS associated with the PDSCH for the second UE. The communications manager 1020 is capable of, configured to, or operable to support a means for receiving, from the first UE, signaling including a beam management report including measurements associated with the DMRS associated with the PDSCH for the second UE. The communications manager 1020 is capable of, configured to, or operable to support a means for adjusting, basing at least in part on the beam management report, a directional beam associated with the first UE.

By including or configuring the communications manager 1020 in accordance with examples as described herein, the device 1005 (e.g., at least one processor controlling or otherwise coupled with the receiver 1010, the transmitter 1015, the communications manager 1020, or a combination thereof) may support techniques for more efficient utilization of communication resources and improved network performance.

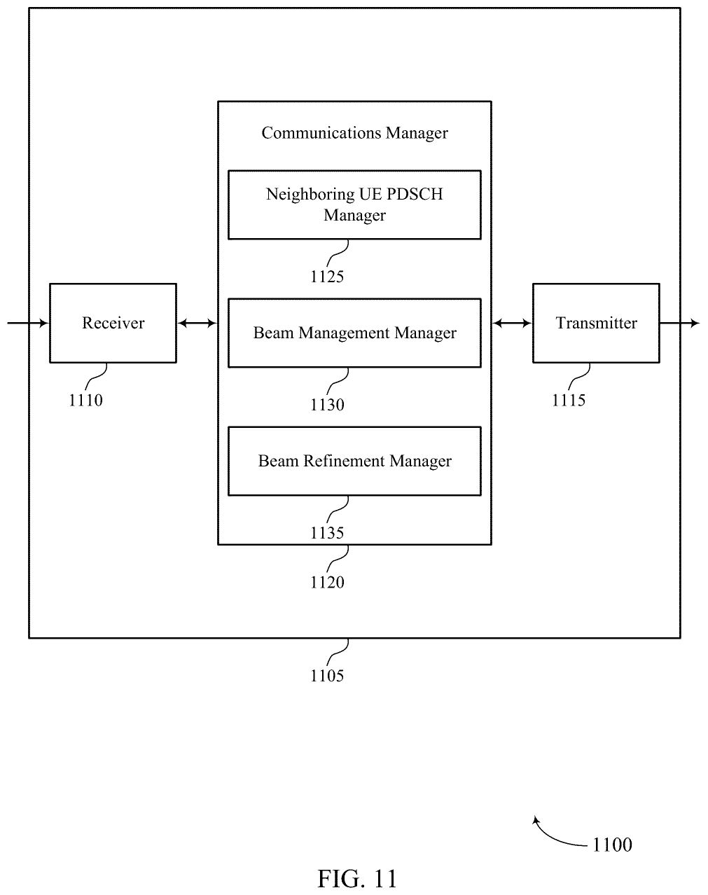

FIG. 11 shows a block diagram 1100 of a device 1105 that supports beam refinement using neighboring UE reference signaling in accordance with one or more aspects of the present disclosure. The device 1105 may be an example of aspects of a device 1005 or a network entity 105 as described herein. The device 1105 may include a receiver 1110, a transmitter 1115, and a communications manager 1120. The device 1105, or one of more components of the device 1105 (e.g., the receiver 1110, the transmitter 1115, and the communications manager 1120), may include at least one processor, which may be coupled with at least one memory, to support the described techniques. Each of these components may be in communication with one another (e.g., via one or more buses).

The receiver 1110 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1105. In some examples, the receiver 1110 may support obtaining information by receiving signals via one or more antennas. Additionally, or alternatively, the receiver 1110 may support obtaining information by receiving signals via one or more wired (e.g., electrical, fiber optic) interfaces, wireless interfaces, or any combination thereof.

The transmitter 1115 may provide a means for outputting (e.g., transmitting, providing, conveying, sending) information generated by other components of the device 1105. For example, the transmitter 1115 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1115 may support outputting information by transmitting signals via one or more antennas. Additionally, or alternatively, the transmitter 1115 may support outputting information by transmitting signals via one or more wired (e.g., electrical, fiber optic) interfaces, wireless interfaces, or any combination thereof. In some examples, the transmitter 1115 and the receiver 1110 may be co-located in a transceiver, which may include or be coupled with a modem.

The device 1105, or various components thereof, may be an example of means for performing various aspects of opportunistic beam refinement using PDSCH DMRSs of neighboring UEs as described herein. For example, the communications manager 1120 may include a neighboring UE PDSCH manager 1125, a beam management manager 1130, a beam refinement manager 1135, or any combination thereof. The communications manager 1120 may be an example of aspects of a communications manager 1020 as described herein. In some examples, the communications manager 1120, or various components thereof, may be configured to perform various operations (e.g., receiving, obtaining, monitoring, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations as described herein.

The communications manager 1120 may support wireless communication in accordance with examples as disclosed herein. The neighboring UE PDSCH manager 1125 is capable of, configured to, or operable to support a means for transmitting, to a first UE, control signaling including an indication of a resource allocation associated with a PDSCH for a second UE and an indication to measure a DMRS associated with the PDSCH for the second UE. The beam management manager 1130 is capable of, configured to, or operable to support a means for receiving, from the first UE, signaling including a beam management report including measurements associated with the DMRS associated with the PDSCH for the second UE. The beam refinement manager 1135 is capable of, configured to, or operable to support a means for adjusting, based on the beam management report, a directional beam associated with the first UE.

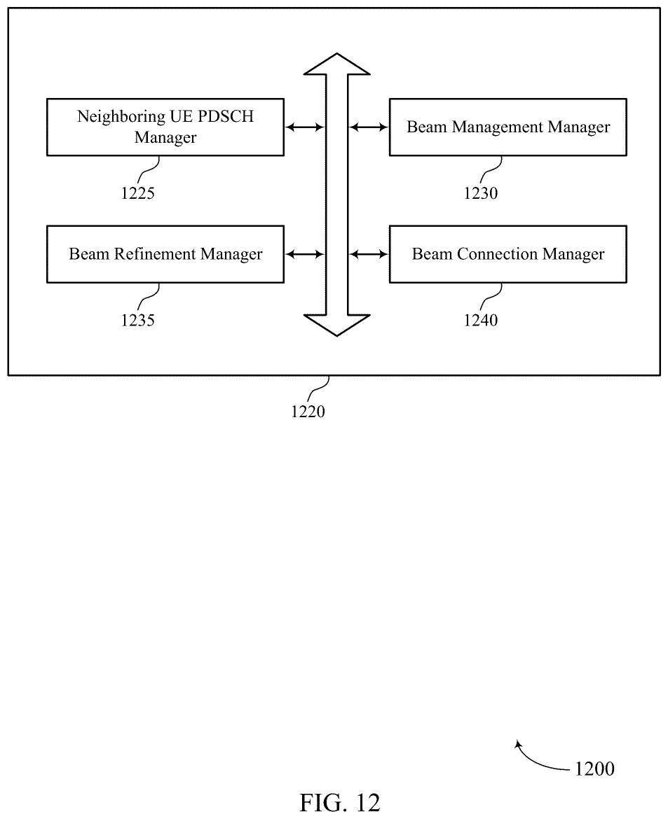

FIG. 12 shows a block diagram 1200 of a communications manager 1220 that supports beam refinement using neighboring UE reference signaling in accordance with one or more aspects of the present disclosure. The communications manager 1220 may be an example of aspects of a communications manager 1020, a communications manager 1120, or both, as described herein. The communications manager 1220, or various components thereof, may be an example of means for performing various aspects of opportunistic beam refinement using PDSCH DMRSs of neighboring UEs as described herein. For example, the communications manager 1220 may include a neighboring UE PDSCH manager 1225, a beam management manager 1230, a beam refinement manager 1235, a beam connection manager 1240, or any combination thereof. Each of these components, or components or subcomponents thereof (e.g., one or more processors, one or more memories), may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1220 may support wireless communication in accordance with examples as disclosed herein. The neighboring UE PDSCH manager 1225 is capable of, configured to, or operable to support a means for transmitting, to a first UE, control signaling including an indication of a resource allocation associated with a PDSCH for a second UE and an indication to measure a DMRS associated with the PDSCH for the second UE. The beam management manager 1230 is capable of, configured to, or operable to support a means for receiving, from the first UE, signaling including a beam management report including measurements associated with the DMRS associated with the PDSCH for the second UE. The beam refinement manager 1235 is capable of, configured to, or operable to support a means for adjusting, based on the beam management report, a directional beam associated with the first UE.

In some examples, the beam refinement manager 1235 is capable of, configured to, or operable to support a means for in response to receiving the signaling including the beam management report: comparing, based on the beam management report, the measurements associated with the DMRS associated with the PDSCH for the second UE to previous measurements, and transmitting, to the first UE and based on the comparing, a notification to switch from a first directional beam to a different directional beam.

In some examples, the previous measurements are associated with the second directional beam and one or more additional directional beams.

In some examples, the previous measurements include synchronization signal block measurements, channel state information-reference signal measurements, unicast DMRS measurements, or a combination thereof.

In some examples, the previous measurements are based on measurements performed by one or more other UEs different from the first UE.

In some examples, the adjusting includes causing the first UE to switch from a first directional beam to a second directional beam.

In some examples, the second directional beam is associated with the second UE.

In some examples, the second directional beam is associated with a third UE.

In some examples, the second directional beam is a newly-configured directional beam.

In some examples, to support adjusting, the beam refinement manager 1235 is capable of, configured to, or operable to support a means for configuring a new directional beam, where the new directional beam is not associated with the first UE or the second UE. In some examples, to support adjusting, the beam refinement manager 1235 is capable of, configured to, or operable to support a means for aligning the new directional beam with a position of the first UE. In some examples, to support adjusting, the beam refinement manager 1235 is capable of, configured to, or operable to support a means for causing the first UE to switch from a first directional beam to the new directional beam.

In some examples, the beam management manager 1230 is capable of, configured to, or operable to support a means for receiving, from the first UE, second signaling recommending a spatial direction of the directional beam to be associated with the first UE, a different directional beam to be associated with the first UE, or a combination thereof.

In some examples, the second signaling indicates a direction of movement of the first UE.

In some examples, the neighboring UE PDSCH manager 1225 is capable of, configured to, or operable to support a means for transmitting, to the first UE and in response to the second signaling, second control signaling including an indication of a second resource allocation associated with a second PDSCH for another UE and an indication to measure a second DMRS associated with the second PDSCH for the other UE.

In some examples, the control signaling further includes an indication that the resource allocation is associated with the second UE.

In some examples, the control signaling further includes an indication of one or more metrics to measure.

In some examples, the control signaling further includes an indication to measure the one or more metrics within each allocated sub-band.

In some examples, the one or more metrics include a reference signal received power, a spectral efficiency, or a combination thereof.

In some examples, the control signaling further includes an indication to transmit, to the network entity, the signaling including the beam management report.

In some examples, the control signaling further includes an indication of a partial resource allocation to use for transmitting the signaling including the beam management report.

In some examples, the control signaling is transmitted in downlink control information or a medium access control-control element.

In some examples, the DMRS includes a unicast DMRS.

In some examples, the beam connection manager 1240 is capable of, configured to, or operable to support a means for establishing, prior to receiving the control signaling and based on a synchronization signal block, a connection with the first UE via a first directional beam.

In some examples, the second UE is in spatial angular proximity to the first UE.

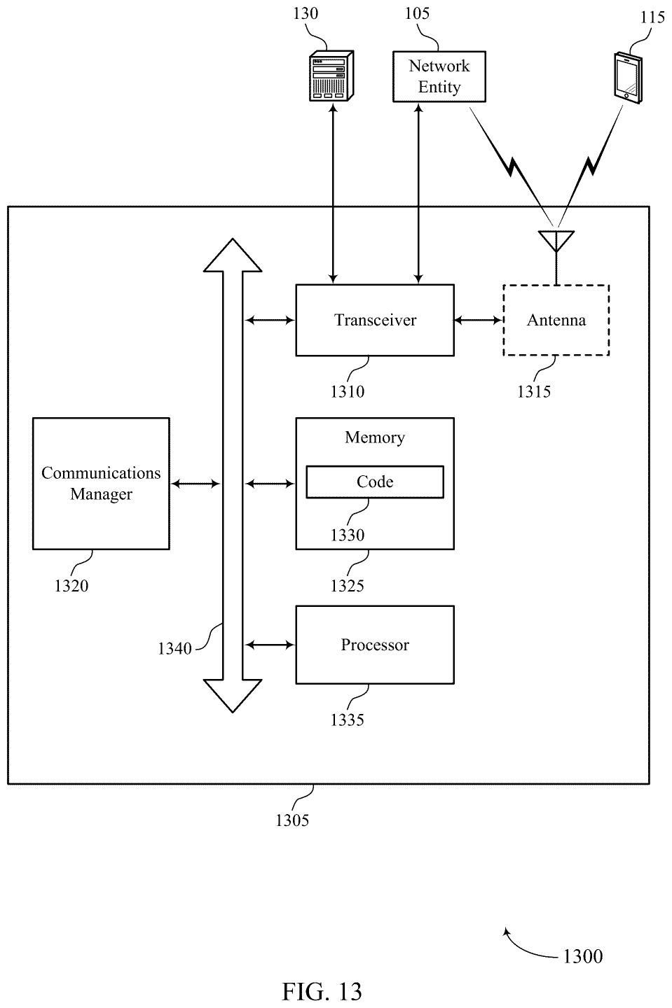

FIG. 13 shows a diagram of a system 1300 including a device 1305 that supports beam refinement using neighboring UE reference signaling in accordance with one or more aspects of the present disclosure. The device 1305 may be an example of or include the components of a device 1005, a device 1105, or a network entity 105 as described herein. The device 1305 may communicate with one or more network entities 105, one or more UEs 115, or any combination thereof, which may include communications over one or more wired interfaces, over one or more wireless interfaces, or any combination thereof. The device 1305 may include components that support outputting and obtaining communications, such as a communications manager 1320, a transceiver 1310, an antenna 1315, at least one memory 1325, code 1330, and at least one processor 1335. These components may be in electronic communication or otherwise coupled (e.g., operatively, communicatively, functionally, electronically, electrically) via one or more buses (e.g., a bus 1340).

The transceiver 1310 may support bi-directional communications via wired links, wireless links, or both as described herein. In some examples, the transceiver 1310 may include a wired transceiver and may communicate bi-directionally with another wired transceiver. Additionally, or alternatively, in some examples, the transceiver 1310 may include a wireless transceiver and may communicate bi-directionally with another wireless transceiver. In some examples, the device 1305 may include one or more antennas 1315, which may be capable of transmitting or receiving wireless transmissions (e.g., concurrently). The transceiver 1310 may also include a modem to modulate signals, to provide the modulated signals for transmission (e.g., by one or more antennas 1315, by a wired transmitter), to receive modulated signals (e.g., from one or more antennas 1315, from a wired receiver), and to demodulate signals. In some implementations, the transceiver 1310 may include one or more interfaces, such as one or more interfaces coupled with the one or more antennas 1315 that are configured to support various receiving or obtaining operations, or one or more interfaces coupled with the one or more antennas 1315 that are configured to support various transmitting or outputting operations, or a combination thereof. In some implementations, the transceiver 1310 may include or be configured for coupling with one or more processors or one or more memory components that are operable to perform or support operations based on received or obtained information or signals, or to generate information or other signals for transmission or other outputting, or any combination thereof. In some implementations, the transceiver 1310, or the transceiver 1310 and the one or more antennas 1315, or the transceiver 1310 and the one or more antennas 1315 and one or more processors or one or more memory components (e.g., the at least one processor 1335, the at least one memory 1325, or both), may be included in a chip or chip assembly that is installed in the device 1305. In some examples, the transceiver 1310 may be operable to support communications via one or more communications links (e.g., a communication link 125, a backhaul communication link 120, a midhaul communication link 162, a fronthaul communication link 168).

The at least one memory 1325 may include RAM, ROM, or any combination thereof. The at least one memory 1325 may store computer-readable, computer-executable code 1330 including instructions that, when executed by one or more of the at least one processor 1335, cause the device 1305 to perform various functions described herein. The code 1330 may be stored in a non-transitory computer-readable medium such as system memory or another type of memory. In some cases, the code 1330 may not be directly executable by a processor of the at least one processor 1335 but may cause a computer (e.g., when compiled and executed) to perform functions described herein. In some cases, the at least one memory 1325 may contain, among other things, a BIOS which may control basic hardware or software operation such as the interaction with peripheral components or devices. In some examples, the at least one processor 1335 may include multiple processors and the at least one memory 1325 may include multiple memories. One or more of the multiple processors may be coupled with one or more of the multiple memories which may, individually or collectively, be configured to perform various functions herein (for example, as part of a processing system).

The at least one processor 1335 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the at least one processor 1335 may be configured to operate a memory array using a memory controller. In some other cases, a memory controller may be integrated into one or more of the at least one processor 1335. The at least one processor 1335 may be configured to execute computer-readable instructions stored in a memory (e.g., one or more of the at least one memory 1325) to cause the device 1305 to perform various functions (e.g., functions or tasks supporting opportunistic beam refinement using PDSCH DMRSs of neighboring UEs). For example, the device 1305 or a component of the device 1305 may include at least one processor 1335 and at least one memory 1325 coupled with one or more of the at least one processor 1335, the at least one processor 1335 and the at least one memory 1325 configured to perform various functions described herein. The at least one processor 1335 may be an example of a cloud-computing platform (e.g., one or more physical nodes and supporting software such as operating systems, virtual machines, or container instances) that may host the functions (e.g., by executing code 1330) to perform the functions of the device 1305. The at least one processor 1335 may be any one or more suitable processors capable of executing scripts or instructions of one or more software programs stored in the device 1305 (such as within one or more of the at least one memory 1325). In some examples, the at least one processor 1335 may include multiple processors and the at least one memory 1325 may include multiple memories. One or more of the multiple processors may be coupled with one or more of the multiple memories, which may, individually or collectively, be configured to perform various functions herein. In some examples, the at least one processor 1335 may be a component of a processing system, which may refer to a system (such as a series) of machines, circuitry (including, for example, one or both of processor circuitry (which may include the at least one processor 1335) and memory circuitry (which may include the at least one memory 1325)), or components, that receives or obtains inputs and processes the inputs to produce, generate, or obtain a set of outputs. The processing system may be configured to perform one or more of the functions described herein. As such, the at least one processor 1335 or a processing system including the at least one processor 1335 may be configured to, configurable to, or operable to cause the device 1305 to perform one or more of the functions described herein. Further, as described herein, being “configured to,” being “configurable to,” and being “operable to” may be used interchangeably and may be associated with a capability, when executing code stored in the at least one memory 1325 or otherwise, to perform one or more of the functions described herein.

In some examples, a bus 1340 may support communications of (e.g., within) a protocol layer of a protocol stack. In some examples, a bus 1340 may support communications associated with a logical channel of a protocol stack (e.g., between protocol layers of a protocol stack), which may include communications performed within a component of the device 1305, or between different components of the device 1305 that may be co-located or located in different locations (e.g., where the device 1305 may refer to a system in which one or more of the communications manager 1320, the transceiver 1310, the at least one memory 1325, the code 1330, and the at least one processor 1335 may be located in one of the different components or divided between different components).

In some examples, the communications manager 1320 may manage aspects of communications with a core network 130 (e.g., via one or more wired or wireless backhaul links). For example, the communications manager 1320 may manage the transfer of data communications for client devices, such as one or more UEs 115. In some examples, the communications manager 1320 may manage communications with other network entities 105, and may include a controller or scheduler for controlling communications with UEs 115 in cooperation with other network entities 105. In some examples, the communications manager 1320 may support an X2 interface within an LTE/LTE-A wireless communications network technology to provide communication between network entities 105.

The communications manager 1320 may support wireless communication in accordance with examples as disclosed herein. For example, the communications manager 1320 is capable of, configured to, or operable to support a means for transmitting, to a first UE, control signaling including an indication of a resource allocation associated with a PDSCH for a second UE and an indication to measure a DMRS associated with the PDSCH for the second UE. The communications manager 1320 is capable of, configured to, or operable to support a means for receiving, from the first UE, signaling including a beam management report including measurements associated with the DMRS associated with the PDSCH for the second UE. The communications manager 1320 is capable of, configured to, or operable to support a means for adjusting, basing at least in part on the beam management report, a directional beam associated with the first UE.

By including or configuring the communications manager 1320 in accordance with examples as described herein, the device 1305 may support techniques for improved communication reliability and more efficient utilization of communication resources.

In some examples, the communications manager 1320 may be configured to perform various operations (e.g., receiving, obtaining, monitoring, outputting, transmitting) using or otherwise in cooperation with the transceiver 1310, the one or more antennas 1315 (e.g., where applicable), or any combination thereof. Although the communications manager 1320 is illustrated as a separate component, in some examples, one or more functions described with reference to the communications manager 1320 may be supported by or performed by the transceiver 1310, one or more of the at least one processor 1335, one or more of the at least one memory 1325, the code 1330, or any combination thereof (for example, by a processing system including at least a portion of the at least one processor 1335, the at least one memory 1325, the code 1330, or any combination thereof). For example, the code 1330 may include instructions executable by one or more of the at least one processor 1335 to cause the device 1305 to perform various aspects of opportunistic beam refinement using PDSCH DMRSs of neighboring UEs as described herein, or the at least one processor 1335 and the at least one memory 1325 may be otherwise configured to, individually or collectively, perform or support such operations.

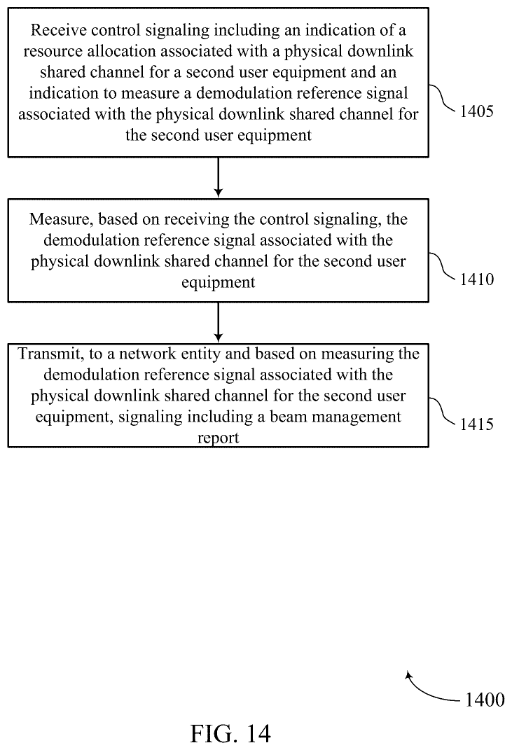

FIG. 14 shows a flowchart illustrating a method 1400 that supports beam refinement using neighboring UE reference signaling in accordance with aspects of the present disclosure. The operations of the method 1400 may be implemented by a UE or its components as described herein. For example, the operations of the method 1400 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1405, the method may include receiving control signaling including an indication of a resource allocation associated with a PDSCH for a second UE and an indication to measure a DMRS associated with the PDSCH for the second UE. The operations of block 1405 may be performed in accordance with examples as disclosed herein. In some examples, aspects of the operations of 1405 may be performed by a neighboring UE PDSCH manager 825 as described with reference to FIG. 8.

At 1410, the method may include measuring, based on receiving the control signaling, the DMRS associated with the PDSCH for the second UE. The operations of block 1410 may be performed in accordance with examples as disclosed herein. In some examples, aspects of the operations of 1410 may be performed by a DMRS measurement manager 830 as described with reference to FIG. 8.

At 1415, the method may include transmitting, to a network entity and based on measuring the DMRS associated with the PDSCH for the second UE, signaling including a beam management report. The operations of block 1415 may be performed in accordance with examples as disclosed herein. In some examples, aspects of the operations of 1415 may be performed by a beam management manager 835 as described with reference to FIG. 8.

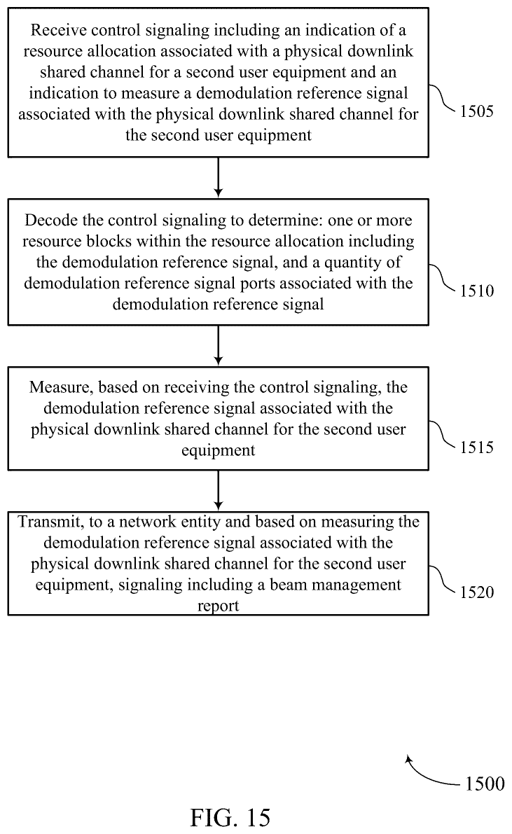

FIG. 15 shows a flowchart illustrating a method 1500 that supports beam refinement using neighboring UE reference signaling in accordance with aspects of the present disclosure. The operations of the method 1500 may be implemented by a UE or its components as described herein. For example, the operations of the method 1500 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1505, the method may include receiving control signaling including an indication of a resource allocation associated with a PDSCH for a second UE and an indication to measure a DMRS associated with the PDSCH for the second UE. The operations of block 1505 may be performed in accordance with examples as disclosed herein. In some examples, aspects of the operations of 1505 may be performed by a neighboring UE PDSCH manager 825 as described with reference to FIG. 8.

At 1510, the method may include decoding the control signaling to determine: one or more resource blocks within the resource allocation including the DMRS, and a quantity of DMRS ports associated with the DMRS. The operations of block 1510 may be performed in accordance with examples as disclosed herein. In some examples, aspects of the operations of 1510 may be performed by a DMRS measurement manager 830 as described with reference to FIG. 8.

At 1515, the method may include measuring, based on receiving the control signaling, the DMRS associated with the PDSCH for the second UE. The operations of block 1515 may be performed in accordance with examples as disclosed herein. In some examples, aspects of the operations of 1515 may be performed by a DMRS measurement manager 830 as described with reference to FIG. 8.

At 1520, the method may include transmitting, to a network entity and based on measuring the DMRS associated with the PDSCH for the second UE, signaling including a beam management report. The operations of block 1520 may be performed in accordance with examples as disclosed herein. In some examples, aspects of the operations of 1520 may be performed by a beam management manager 835 as described with reference to FIG. 8.

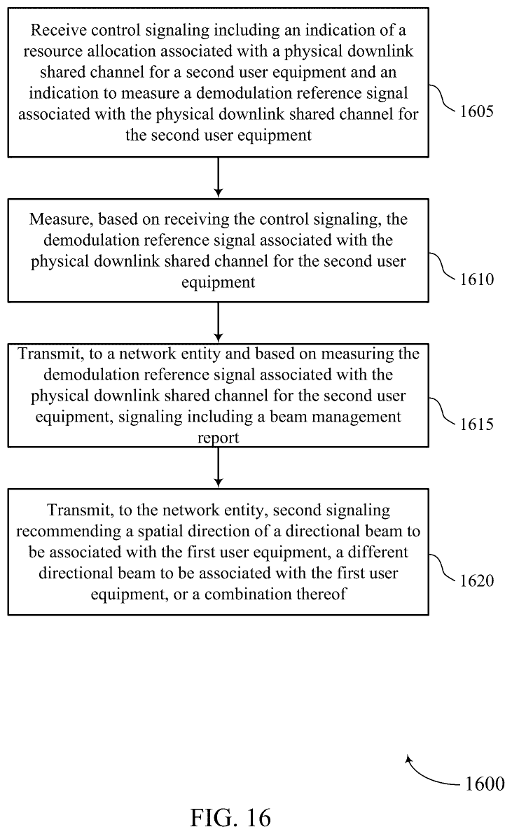

FIG. 16 shows a flowchart illustrating a method 1600 that supports beam refinement using neighboring UE reference signaling in accordance with aspects of the present disclosure. The operations of the method 1600 may be implemented by a UE or its components as described herein. For example, the operations of the method 1600 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1605, the method may include receiving control signaling including an indication of a resource allocation associated with a PDSCH for a second UE and an indication to measure a DMRS associated with the PDSCH for the second UE. The operations of block 1605 may be performed in accordance with examples as disclosed herein. In some examples, aspects of the operations of 1605 may be performed by a neighboring UE PDSCH manager 825 as described with reference to FIG. 8.

At 1610, the method may include measuring, based on receiving the control signaling, the DMRS associated with the PDSCH for the second UE. The operations of block 1610 may be performed in accordance with examples as disclosed herein. In some examples, aspects of the operations of 1610 may be performed by a DMRS measurement manager 830 as described with reference to FIG. 8.

At 1615, the method may include transmitting, to a network entity and based on measuring the DMRS associated with the PDSCH for the second UE, signaling including a beam management report. The operations of block 1615 may be performed in accordance with examples as disclosed herein. In some examples, aspects of the operations of 1615 may be performed by a beam management manager 835 as described with reference to FIG. 8.

At 1620, the method may include transmitting, to the network entity, second signaling recommending a spatial direction of a directional beam to be associated with the first UE, a different directional beam to be associated with the first UE, or a combination thereof. The operations of block 1620 may be performed in accordance with examples as disclosed herein. In some examples, aspects of the operations of 1620 may be performed by a beam management manager 835 as described with reference to FIG. 8.

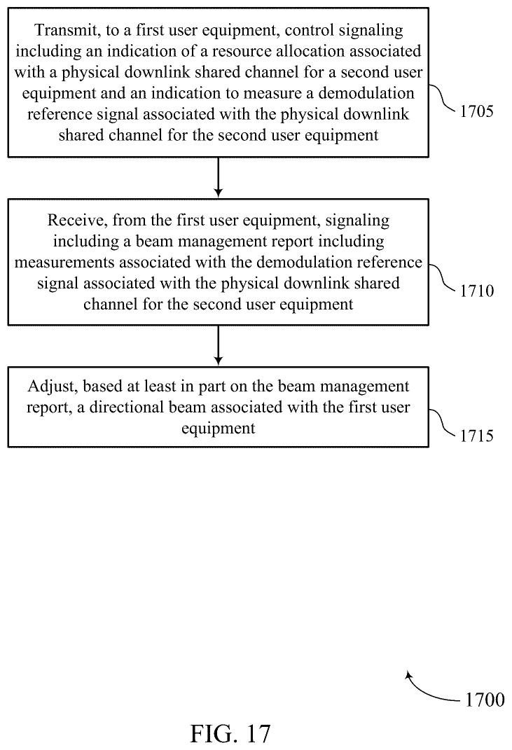

FIG. 17 shows a flowchart illustrating a method 1700 that supports beam refinement using neighboring UE reference signaling in accordance with aspects of the present disclosure. The operations of the method 1700 may be implemented by a network entity or its components as described herein. For example, the operations of the method 1700 may be performed by a network entity as described with reference to FIGS. 1 through 5 and 10 through 13. In some examples, a network entity may execute a set of instructions to control the functional elements of the network entity to perform the described functions. Additionally, or alternatively, the network entity may perform aspects of the described functions using special-purpose hardware.

At 1705, the method may include transmitting, to a first UE, control signaling including an indication of a resource allocation associated with a PDSCH for a second UE and an indication to measure a DMRS associated with the PDSCH for the second UE. The operations of block 1705 may be performed in accordance with examples as disclosed herein. In some examples, aspects of the operations of 1705 may be performed by a neighboring UE PDSCH manager 1225 as described with reference to FIG. 12.

At 1710, the method may include receiving, from the first UE, signaling including a beam management report including measurements associated with the DMRS associated with the PDSCH for the second UE. The operations of block 1710 may be performed in accordance with examples as disclosed herein. In some examples, aspects of the operations of 1710 may be performed by a beam management manager 1230 as described with reference to FIG. 12.

At 1715, the method may include adjusting, based on the beam management report, a directional beam associated with the first UE. The operations of block 1715 may be performed in accordance with examples as disclosed herein. In some examples, aspects of the operations of 1715 may be performed by a beam refinement manager 1235 as described with reference to FIG. 12.

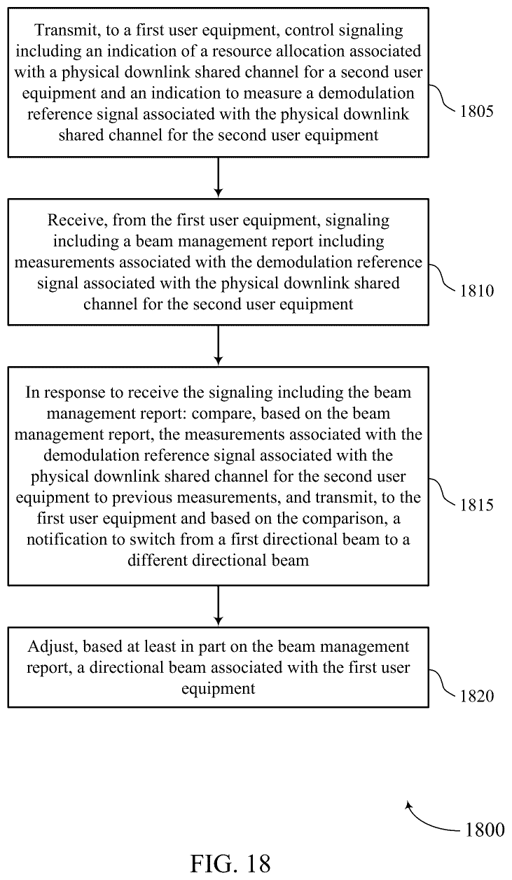

FIG. 18 shows a flowchart illustrating a method 1800 that supports beam refinement using neighboring UE reference signaling in accordance with aspects of the present disclosure. The operations of the method 1800 may be implemented by a network entity or its components as described herein. For example, the operations of the method 1800 may be performed by a network entity as described with reference to FIGS. 1 through 5 and 10 through 13. In some examples, a network entity may execute a set of instructions to control the functional elements of the network entity to perform the described functions. Additionally, or alternatively, the network entity may perform aspects of the described functions using special-purpose hardware.

At 1805, the method may include transmitting, to a first UE, control signaling including an indication of a resource allocation associated with a PDSCH for a second UE and an indication to measure a DMRS associated with the PDSCH for the second UE. The operations of block 1805 may be performed in accordance with examples as disclosed herein. In some examples, aspects of the operations of 1805 may be performed by a neighboring UE PDSCH manager 1225 as described with reference to FIG. 12.

At 1810, the method may include receiving, from the first UE, signaling including a beam management report including measurements associated with the DMRS associated with the PDSCH for the second UE. The operations of block 1810 may be performed in accordance with examples as disclosed herein. In some examples, aspects of the operations of 1810 may be performed by a beam management manager 1230 as described with reference to FIG. 12.

At 1815, the method may include in response to receiving the signaling including the beam management report: comparing, based on the beam management report, the measurements associated with the DMRS associated with the PDSCH for the second UE to previous measurements, and transmitting, to the first UE and based on the comparing, a notification to switch from a first directional beam to a different directional beam. The operations of block 1815 may be performed in accordance with examples as disclosed herein. In some examples, aspects of the operations of 1815 may be performed by a beam refinement manager 1235 as described with reference to FIG. 12.

At 1820, the method may include adjusting, based on the beam management report, a directional beam associated with the first UE. The operations of block 1820 may be performed in accordance with examples as disclosed herein. In some examples, aspects of the operations of 1820 may be performed by a beam refinement manager 1235 as described with reference to FIG. 12.

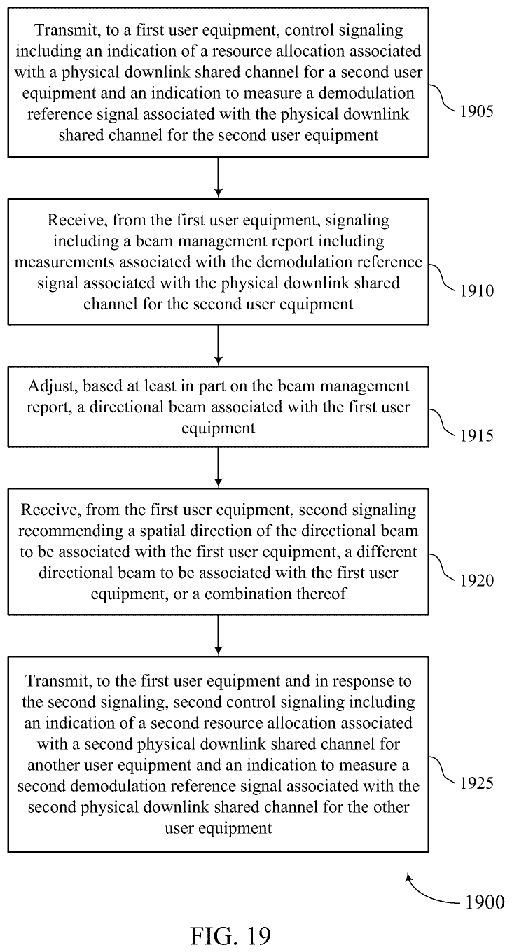

FIG. 19 shows a flowchart illustrating a method 1900 that supports beam refinement using neighboring UE reference signaling in accordance with aspects of the present disclosure. The operations of the method 1900 may be implemented by a network entity or its components as described herein. For example, the operations of the method 1900 may be performed by a network entity as described with reference to FIGS. 1 through 5 and 10 through 13. In some examples, a network entity may execute a set of instructions to control the functional elements of the network entity to perform the described functions. Additionally, or alternatively, the network entity may perform aspects of the described functions using special-purpose hardware.

At 1905, the method may include transmitting, to a first UE, control signaling including an indication of a resource allocation associated with a PDSCH for a second UE and an indication to measure a DMRS associated with the PDSCH for the second UE. The operations of block 1905 may be performed in accordance with examples as disclosed herein. In some examples, aspects of the operations of 1905 may be performed by a neighboring UE PDSCH manager 1225 as described with reference to FIG. 12.

At 1910, the method may include receiving, from the first UE, signaling including a beam management report including measurements associated with the DMRS associated with the PDSCH for the second UE. The operations of block 1910 may be performed in accordance with examples as disclosed herein. In some examples, aspects of the operations of 1910 may be performed by a beam management manager 1230 as described with reference to FIG. 12.

At 1915, the method may include adjusting, based on the beam management report, a directional beam associated with the first UE. The operations of block 1915 may be performed in accordance with examples as disclosed herein. In some examples, aspects of the operations of 1915 may be performed by a beam refinement manager 1235 as described with reference to FIG. 12.

At 1920, the method may include receiving, from the first UE, second signaling recommending a spatial direction of the directional beam to be associated with the first UE, a different directional beam to be associated with the first UE, or a combination thereof. The operations of block 1920 may be performed in accordance with examples as disclosed herein. In some examples, aspects of the operations of 1920 may be performed by a beam management manager 1230 as described with reference to FIG. 12.

At 1925, the method may include transmitting, to the first UE and in response to the second signaling, second control signaling including an indication of a second resource allocation associated with a second PDSCH for another UE and an indication to measure a second DMRS associated with the second PDSCH for the other UE. The operations of block 1925 may be performed in accordance with examples as disclosed herein. In some examples, aspects of the operations of 1925 may be performed by a neighboring UE PDSCH manager 1225 as described with reference to FIG. 12.

The following provides an overview of aspects of the present disclosure:

Aspect 1: A method for wireless communications by a first user equipment, comprising: receiving control signaling comprising an indication of a resource allocation associated with a physical downlink shared channel for a second user equipment and an indication to measure a demodulation reference signal associated with the physical downlink shared channel for the second user equipment; measuring, based at least in part on receiving the control signaling, the demodulation reference signal associated with the physical downlink shared channel for the second user equipment; and transmitting, to a network device and based at least in part on measuring the demodulation reference signal associated with the physical downlink shared channel for the second user equipment, signaling comprising a beam management report.

Aspect 2: The method of aspect 1, wherein the control signaling further comprises an indication that the resource allocation is associated with the second user equipment.

Aspect 3: The method of any of aspects 1 through 2, wherein the control signaling further comprises an indication of one or more metrics to measure.

Aspect 4: The method of aspect 3, wherein measuring the demodulation reference signal comprises measuring, using the demodulation reference signal, the one or more metrics.

Aspect 5: The method of any of aspects 3 through 4, wherein the control signaling further comprises an indication to measure the one or more metrics within each allocated sub-band, and wherein measuring the demodulation reference signal comprises measuring, using the demodulation reference signal, the one or more metrics within each allocated sub-band.

Aspect 6: The method of any of aspects 3 through 5, wherein the one or more metrics comprise a reference signal received power, a spectral efficiency, or a combination thereof.

Aspect 7: The method of any of aspects 1 through 6, further comprising: decoding the control signaling to determine: one or more resource blocks within the resource allocation comprising the demodulation reference signal, and a quantity of demodulation reference signal ports associated with the demodulation reference signal.

Aspect 8: The method of any of aspects 1 through 7, wherein the control signaling further comprises an indication to transmit, to the network device, the signaling comprising the beam management report.

Aspect 9: The method of any of aspects 1 through 8, wherein the control signaling further comprises an indication of a partial resource allocation to use for transmitting the signaling comprising the beam management report.

Aspect 10: The method of any of aspects 1 through 9, wherein the control signaling is received in downlink control information or a medium access control-control element.

Aspect 11: The method of any of aspects 1 through 10, wherein the demodulation reference signal comprises a unicast demodulation reference signal.

Aspect 12: The method of any of aspects 1 through 11, further comprising: establishing, prior to receiving the control signaling and based at least in part on a synchronization signal block, a connection with the network device via a first directional beam.

Aspect 13: The method of any of aspects 1 through 12, further comprising: receiving, from the network device and responsive to transmission of the signaling comprising the beam management report, a message notifying the first user equipment to switch from a first directional beam to a second directional beam.

Aspect 14: The method of aspect 13, wherein the second directional beam is associated with the second user equipment.

Aspect 15: The method of any of aspects 13 through 14, wherein the second directional beam is a directional beam associated with a third user equipment.

Aspect 16: The method of any of aspects 13 through 15, wherein the second directional beam is a newly-configured directional beam.

Aspect 17: The method of any of aspects 13 through 16, further comprising: receiving, from the network device, a subsequent data transmission via the second directional beam.

Aspect 18: The method of any of aspects 1 through 17, wherein the second user equipment is in spatial angular proximity to the first user equipment.

Aspect 19: The method of any of aspects 1 through 18, further comprising: transmitting, to the network device, second signaling recommending a spatial direction of a directional beam to be associated with the first user equipment, a different directional beam to be associated with the first user equipment, or a combination thereof.

Aspect 20: The method of aspect 19, wherein the second signaling is transmitted based at least in part on movement detected at the first user equipment, a changed location of the first user equipment, or a changed direction of the first user equipment.

Aspect 21: The method of any of aspects 19 through 20, wherein the second signaling indicates a direction of movement of the first user equipment.

Aspect 22: A method for wireless communication by a network device, comprising: transmitting, to a first user equipment, control signaling comprising an indication of a resource allocation associated with a physical downlink shared channel for a second user equipment and an indication to measure a demodulation reference signal associated with the physical downlink shared channel for the second user equipment; receiving, from the first user equipment, signaling comprising a beam management report including measurements associated with the demodulation reference signal associated with the physical downlink shared channel for the second user equipment; and adjusting, based at least in part on the beam management report, a directional beam associated with the first user equipment.

Aspect 23: The method of aspect 22, further comprising: in response to receiving the signaling comprising the beam management report: comparing, based at least in part on the beam management report, the measurements associated with the demodulation reference signal associated with the physical downlink shared channel for the second user equipment to previous measurements; and transmitting, to the first user equipment and based at least in part on the comparing, a notification to switch from a first directional beam to a different directional beam.

Aspect 24: The method of aspect 23, wherein the measurements associated with the demodulation reference signal are associated with a second directional beam that is associated with the second user equipment, and wherein the previous measurements are associated with the second directional beam and one or more additional directional beams.

Aspect 25: The method of any of aspects 23 through 24, wherein the previous measurements comprise synchronization signal block measurements, channel state information-reference signal measurements, unicast demodulation reference signal measurements, or a combination thereof.

Aspect 26: The method of any of aspects 23 through 25, wherein the previous measurements are based at least in part on measurements performed by one or more other user equipments different from the first user equipment.

Aspect 27: The method of any of aspects 22 through 26, wherein the adjusting comprises causing the first user equipment to switch from a first directional beam to a second directional beam.

Aspect 28: The method of aspect 27, wherein the second directional beam is associated with the second user equipment.

Aspect 29: The method of any of aspects 27 through 28, wherein the second directional beam is associated with a third user equipment.

Aspect 30: The method of any of aspects 27 through 29, wherein the second directional beam is a newly-configured directional beam.

Aspect 31: The method of any of aspects 22 through 30, wherein the adjusting comprises: configuring a new directional beam, wherein the new directional beam is not associated with the first user equipment or the second user equipment; aligning the new directional beam with a position of the first user equipment; and causing the first user equipment to switch from a first directional beam to the new directional beam.

Aspect 32: The method of any of aspects 22 through 31, further comprising: receiving, from the first user equipment, second signaling recommending a spatial direction of the directional beam to be associated with the first user equipment, a different directional beam to be associated with the first user equipment, or a combination thereof.

Aspect 33: The method of aspect 32, wherein the second signaling indicates a direction of movement of the first user equipment.

Aspect 34: The method of any of aspects 32 through 33, further comprising: transmitting, to the first user equipment and in response to the second signaling, second control signaling comprising an indication of a second resource allocation associated with a second physical downlink shared channel for another user equipment and an indication to measure a second demodulation reference signal associated with the physical downlink shared channel for the other user equipment.

Aspect 35: The method of any of aspects 22 through 34, wherein the control signaling further comprises an indication that the resource allocation is associated with the second user equipment.

Aspect 36: The method of any of aspects 22 through 35, wherein the control signaling further comprises an indication of one or more metrics to measure.

Aspect 37: The method of aspect 36, wherein the control signaling further comprises an indication to measure the one or more metrics within each allocated sub-band.

Aspect 38: The method of any of aspects 36 through 37, wherein the one or more metrics comprise a reference signal received power, a spectral efficiency, or a combination thereof.

Aspect 39: The method of any of aspects 22 through 38, wherein the control signaling further comprises an indication to transmit, to the network device, the signaling comprising the beam management report.

Aspect 40: The method of any of aspects 22 through 39, wherein the control signaling further comprises an indication of a partial resource allocation to use for transmitting the signaling comprising the beam management report.

Aspect 41: The method of any of aspects 22 through 40, wherein the control signaling is transmitted in downlink control information or a medium access control-control element.

Aspect 42: The method of any of aspects 22 through 41, wherein the demodulation reference signal associated comprises a unicast demodulation reference signal.

Aspect 43: The method of any of aspects 22 through 42, further comprising: establishing, prior to receiving the control signaling and based at least in part on a synchronization signal block, a connection with the first user equipment via a first directional beam.

Aspect 44: The method of any of aspects 22 through 43, wherein the second user equipment is in spatial angular proximity to the first user equipment.

Aspect 45: A first user equipment for wireless communications, comprising one or more memories storing processor-executable code, and one or more processors coupled with the one or more memories and individually or collectively operable to execute the code to cause the first user equipment to perform a method of any of aspects 1 through 21.

Aspect 46: A first user equipment for wireless communications, comprising at least one means for performing a method of any of aspects 1 through 21.

Aspect 47: A non-transitory computer-readable medium storing code for wireless communications, the code comprising instructions executable by a processor to perform a method of any of aspects 1 through 21.

Aspect 48: A network device for wireless communication, comprising one or more memories storing processor-executable code, and one or more processors coupled with the one or more memories and individually or collectively operable to execute the code to cause the network device to perform a method of any of aspects 22 through 44.

Aspect 49: A network device for wireless communication, comprising at least one means for performing a method of any of aspects 22 through 44.

Aspect 50: A non-transitory computer-readable medium storing code for wireless communication, the code comprising instructions executable by a processor to perform a method of any of aspects 22 through 44.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope and spirit of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. As used herein, including in the claims, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination. Also, as used herein, including in the claims, “or” as used in a list of items (for example, a list of items prefaced by a phrase such as “at least one of” or “one or more of”) indicates a disjunctive list such that, for example, a list of “at least one of A, B, or C” means A or B or C or AB or AC or BC or ABC (i.e., A and B and C).

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A first user equipment, comprising:
one or more memories storing processor-executable code; and
one or more processors coupled with the one or more memories and individually or collectively operable to execute the code to cause the first user equipment to:
receive control signaling comprising an indication of a resource allocation associated with a physical downlink shared channel for a second user equipment and an indication to measure a demodulation reference signal associated with the physical downlink shared channel for the second user equipment;
measure, based at least in part on receiving the control signaling, the demodulation reference signal associated with the physical downlink shared channel for the second user equipment; and
transmit, to a network entity and based at least in part on measuring the demodulation reference signal associated with the physical downlink shared channel for the second user equipment, signaling comprising a beam management report.

2. The first user equipment of claim 1, wherein the control signaling further comprises an indication of one or more metrics to measure, and wherein, to measure the demodulation reference signal, the one or more processors are individually or collectively further operable to execute the code to cause the first user equipment to measure, using the demodulation reference signal, the one or more metrics.

3. The first user equipment of claim 2, wherein the one or more metrics comprise a reference signal received power, a spectral efficiency, or a combination thereof.

4. The first user equipment of claim 1, wherein the one or more processors are individually or collectively further operable to execute the code to cause the first user equipment to:
decode the control signaling to determine:
one or more resource blocks within the resource allocation comprise the demodulation reference signal, and
a quantity of demodulation reference signal ports associate with the demodulation reference signal.

5. The first user equipment of claim 1, wherein the one or more processors are individually or collectively further operable to execute the code to cause the first user equipment to:
receive, from the network entity and responsive to transmission of the signaling comprising the beam management report, a message notifying the first user equipment to switch from a first directional beam to a second directional beam.

6. The first user equipment of claim 5, wherein the second directional beam is associated with the second user equipment, is associated with a third user equipment, or is a newly-configured directional beam.

7. The first user equipment of claim 1, wherein the one or more processors are individually or collectively further operable to execute the code to cause the first user equipment to:
transmit, to the network entity, second signaling recommending a spatial direction of a directional beam to be associated with the first user equipment, a different directional beam to be associated with the first user equipment, or a combination thereof.

8. The first user equipment of claim 7, wherein the second signaling is transmitted based at least in part on movement detected at the first user equipment, a changed location of the first user equipment, or a changed direction of the first user equipment.

9. A network entity, comprising:
one or more memories storing processor-executable code; and
one or more processors coupled with the one or more memories and individually or collectively operable to execute the code to cause the network entity to:
transmit, to a first user equipment, control signaling comprising an indication of a resource allocation associated with a physical downlink shared channel for a second user equipment and an indication to measure a demodulation reference signal associated with the physical downlink shared channel for the second user equipment;
receive, from the first user equipment, signaling comprising a beam management report including measurements associated with the demodulation reference signal associated with the physical downlink shared channel for the second user equipment; and
adjust, based at least in part on the beam management report, a directional beam associated with the first user equipment.

10. The network entity of claim 9, wherein the one or more processors are individually or collectively further operable to execute the code to cause the network entity to:
in response to receiving the signaling comprising the beam management report:
compare, based at least in part on the beam management report, the measurements associated with the demodulation reference signal associated with the physical downlink shared channel for the second user equipment to previous measurements; and
transmit, to the first user equipment and based at least in part on the comparison, a notification to switch from a first directional beam to a different directional beam.

11. The network entity of claim 10, wherein the measurements associated with the demodulation reference signal are associated with a second directional beam that is associated with the second user equipment, and wherein the previous measurements are associated with the second directional beam and one or more additional directional beams.

12. The network entity of claim 9, wherein, to adjust the directional beam associated with the first user equipment, the one or more processors are individually or collectively operable to execute the code to cause the network entity to cause the first user equipment to switch from a first directional beam to a second directional beam, wherein the second directional beam is associated with the second user equipment, is associated with a third user equipment, or is a newly-configured directional beam.

13. The network entity of claim 9, wherein the one or more processors are individually or collectively further operable to execute the code to cause the network entity to:
receive, from the first user equipment, second signaling recommending a spatial direction of the directional beam to be associated with the first user equipment, a different directional beam to be associated with the first user equipment, or a combination thereof.

14. The network entity of claim 13, wherein the one or more processors are individually or collectively further operable to execute the code to cause the network entity to:
transmit, to the first user equipment and in response to the second signaling, second control signaling comprising an indication of a second resource allocation associated with a second physical downlink shared channel for another user equipment and an indication to measure a second demodulation reference signal associated with the second physical downlink shared channel for the other user equipment.

15. The network entity of claim 9, wherein the control signaling further comprises an indication of one or more metrics to measure, wherein the one or more metrics comprise a reference signal received power, a spectral efficiency, or a combination thereof.

16. A method for wireless communications by a first user equipment, comprising:
receiving control signaling comprising an indication of a resource allocation associated with a physical downlink shared channel for a second user equipment and an indication to measure a demodulation reference signal associated with the physical downlink shared channel for the second user equipment;
measuring, based at least in part on receiving the control signaling, the demodulation reference signal associated with the physical downlink shared channel for the second user equipment; and
transmitting, to a network entity and based at least in part on measuring the demodulation reference signal associated with the physical downlink shared channel for the second user equipment, signaling comprising a beam management report.

17. The method of claim 16, wherein the control signaling further comprises an indication of one or more metrics to measure, and wherein measuring the demodulation reference signal comprises measuring, using the demodulation reference signal, the one or more metrics.

18. The method of claim 17, wherein the one or more metrics comprise a reference signal received power, a spectral efficiency, or a combination thereof.

19. The method of claim 16, further comprising:
decoding the control signaling to determine:
one or more resource blocks within the resource allocation comprising the demodulation reference signal, and
a quantity of demodulation reference signal ports associated with the demodulation reference signal.

20. The method of claim 16, further comprising:
receiving, from the network entity and responsive to transmission of the signaling comprising the beam management report, a message notifying the first user equipment to switch from a first directional beam to a second directional beam.

21. The method of claim 20, wherein the second directional beam is associated with the second user equipment, is associated with a third user equipment, or is a newly-configured directional beam.

22. The method of claim 16, further comprising:
transmitting, to the network entity, second signaling recommending a spatial direction of a directional beam to be associated with the first user equipment, a different directional beam to be associated with the first user equipment, or a combination thereof.

23. The method of claim 22, wherein the second signaling is transmitted based at least in part on movement detected at the first user equipment, a changed location of the first user equipment, or a changed direction of the first user equipment.

24. A method for wireless communication by a network entity, comprising:
transmitting, to a first user equipment, control signaling comprising an indication of a resource allocation associated with a physical downlink shared channel for a second user equipment and an indication to measure a demodulation reference signal associated with the physical downlink shared channel for the second user equipment;
receiving, from the first user equipment, signaling comprising a beam management report including measurements associated with the demodulation reference signal associated with the physical downlink shared channel for the second user equipment; and
adjusting, based at least in part on the beam management report, a directional beam associated with the first user equipment.

25. The method of claim 24, further comprising:
in response to receiving the signaling comprising the beam management report:
comparing, based at least in part on the beam management report, the measurements associated with the demodulation reference signal associated with the physical downlink shared channel for the second user equipment to previous measurements; and
transmitting, to the first user equipment and based at least in part on the comparing, a notification to switch from a first directional beam to a different directional beam.

26. The method of claim 25, wherein the measurements associated with the demodulation reference signal are associated with a second directional beam that is associated with the second user equipment, and wherein the previous measurements are associated with the second directional beam and one or more additional directional beams.

27. The method of claim 24, wherein the adjusting comprises causing the first user equipment to switch from a first directional beam to a second directional beam, wherein the second directional beam is associated with the second user equipment, is associated with a third user equipment, or is a newly-configured directional beam.

28. The method of claim 24, further comprising:
receiving, from the first user equipment, second signaling recommending a spatial direction of the directional beam to be associated with the first user equipment, a different directional beam to be associated with the first user equipment, or a combination thereof.

29. The method of claim 28, further comprising:
transmitting, to the first user equipment and in response to the second signaling, second control signaling comprising an indication of a second resource allocation associated with a second physical downlink shared channel for another user equipment and an indication to measure a second demodulation reference signal associated with the second physical downlink shared channel for the other user equipment.

30. The method of claim 24, wherein the control signaling further comprises an indication of one or more metrics to measure, wherein the one or more metrics comprise a reference signal received power, a spectral efficiency, or a combination thereof.
